(19) United States
(12) Patent Application Publication
(10) Pub. No.: US 2026/0032493 A1
(43) Pub. Date: Jan. 29, 2026

(54) Methods, Apparatus and Computer-Readable Media for the Reporting of Quality of Experience Information in a Communications Network

(71) Applicant: Telefonaktiebolaget LM Ericsson (publ), Stockholm (SE)

(72) Inventors: Johan Rune, Lidingö (SE); Cecilia Eklöf, Täby (SE); Luca Lunardi, Genova (IT); Filip Barac, Huddinge (SE)

(21) Appl. No.: 19/099,070

(22) PCT Filed: Aug. 3, 2023
(86) PCT No.: PCT/EP2023/071605

§ 371 Date: Jan. 28, 2025

Related U.S. Application Data
(60) Provisional application No. 63/395,076, filed on Aug. 4, 2022.

(51) Int. Cl. H04W 24/10; H04L 43/062

(52) U.S. Cl. CPC H04W 24/10; H04L 43/062

(57) ABSTRACT

A method is performed by a user equipment (1100) for reporting quality of experience information. The method comprises transmitting, to a network node (1200) of a communications network, a quality of experience measurement report comprising quality of experience measurement data associated with an application session between the user equipment (1100) and the communications network. The method further comprises transmitting, to the network node (1200), an indication of a connectivity state of the user equipment (1100) with respect to the communications network when the application session was initiated.

### TECHNICAL FIELD

Embodiments of the present disclosure relate to methods, apparatus and computer-readable media relating to communications networks, and particularly to the reporting of quality of experience information in communications networks.

### BACKGROUND

### Overview of the QoE Framework

### “Regular” QoE

Quality of Experience (QoE) measurements, also referred to as “application layer measurements”, have been specified for Long Term Evolution (LTE) and Universal Mobile Telecommunications System (UMTS) and are being specified for New Radio (NR) in 3rd Generation Partnership Project (3GPP) release 17. The purpose of the application layer measurements is to measure the end user experience when using certain applications. Currently QoE measurements for streaming services and for Mobility Telephony Service for Internet Protocol (IP) Multimedia Subsystem (IMS) (MTSI) services are supported. For NR, it is likely that at least Virtual Reality (VR) will be added to the list of services for which QoE measurements are specified and supported.

The solutions in LTE and UMTS are similar with the overall principles as follows. Quality of Experience Measurement Collection (QMC) enables configuration of application layer measurements in the User Equipment (UE) and transmission of QoE measurement result files (commonly referred to as QoE reports) to the network by means of Radio Resource Control (RRC) signalling. An application layer measurement configuration (also called QoE measurement configuration or QoE configuration) that the Radio Access Network (RAN) receives from the Operations, Administration and Maintenance (OAM) system or the Core Network (CN) is encapsulated in a transparent container, which is forwarded to a UE in a downlink RRC message. An application layer measurement report (also called QoE report) that the UE Access Stratum (UE AS) or UE RRC layer receives from the UE's higher layer (application layer) is encapsulated in a transparent container and sent to network in an uplink RRC message. The RAN then forwards the QoE report to a Measurement Collector Entity (MCE).

In 3GPP release 17 a new study item for “Study on NR QoE management and optimizations for diverse services” for NR has been approved and concluded. The specification work for 3GPP release 17 is still ongoing. The purpose of the study item is to study solutions for QoE measurements in NR. QoE management in NR will not just collect the quality of experience parameters of streaming services but also consider the typical performance requirements of diverse services (e.g. Augmented Reality (AR)/VR and Ultra-Reliable Low Latency Communications (URLLC), of which at least VR will be covered in 3GPP release 17). Based on requirements of services, the NR study also included more adaptive QoE management schemes that enable network optimization to satisfy user experience for diverse services.

The configuration data related to QoE measurements (in standard specifications typically referred to as application layer measurements) consists of a service type indication, an indication of an area in which the measurements are to be performed (denoted area scope), an IP address of the entity the collected measurement results (i.e. the QoE reports) should be sent to (often referred to as a MCE, spelled out as Measurement Collector Entity or Measurement Collection Entity, but the entity may sometimes also be referred to as a Trace Collection Entity) and a set of instructions of which type of measurements that should be performed and details of how these measurements are to be performed. These instructions are intended for the application layer in the UE and are placed in a “container” which the network entities handling it, e.g., forwarding it to the UE, as well as the UE Access Stratum, cannot interpret and do not try to read. The currently specified service types are MTSI and streaming service (DASH), and in 3GPP release 17, service type VR will be added and QoE measurements on Multicast and Broadcast Services (MBS) will be specified in 3GPP release 18. An area scope is defined in terms of cells or network related areas. In UMTS, an area scope is defined as either a list of cells, a list of routing areas, or a list of tracking areas. In LTE, an area scope is defined as either a list of cells or a list of tracking areas. In NR, an area scope will be defined as either a list of cells or a list of tracking areas.

QoE, and in particular QoE configuration, comes in two flavors: management-based QoE configuration and signaling-based QoE configuration. In both cases the QoE configuration originates in the OAM system or some other administrational entity, e.g., dealing with customer satisfaction. All of these entities are in this document referred to as the OAM system (where the OAM system also contains further entities). With management-based QoE (m-based QoE), the OAM system is typically interested in general QoE statistics from a certain area (which is configured as an area scope). The m-based QoE configuration is sent directly from the OAM system to the RAN nodes controlling cells that are within the area scope. Each RAN node then selects UEs that are within the area scope (and also fulfills any other relevant condition, such as supporting the concerned application/service type) and sends the m-based QoE configuration to these UEs.

With signaling-based QoE (s-based QoE), the OAM system is interested in collecting QoE measurement results from a specific UE, e.g., because the user of the UE has filed a complaint. The OAM system sends the s-based QoE configuration to the Home Subscriber Server (HSS) (in Evolved Packet System (EPS)/LTE) or Unified Data Management (UDM) (in 5GS/NR), which forwards the QoE configuration to the UE's current core network node (CN), e.g., a Mobility Management Entity (MME) in EPS/LTE or an Access & Mobility Management Function (AMF) in 5G/NR. The CN then forwards the s-based QoE configuration to the RAN node that serves the concerned UE and the RAN forwards it to the UE.

Forwarded to the UE are the service type indication and the container with the measurement instructions. The UE is not aware of whether a received QoE configuration is m-based or s-based. In legacy systems, the QoE framework is integrated with the Trace functionality and a Trace ID is associated with each QoE configuration. In NR, the QoE functionality will be logically separated from the Trace functionality, but it will still partly reuse the Trace signaling mechanisms. In NR, and possibly in LTE, a globally unique QoE reference (formed of Mobile Country Code (MCC)+Mobile Network Code (MNC)+QoE Measurement Collection (QMC) ID, where the QMC ID is a string of 24 bits) will be associated with each QoE configuration. The QoE reference is included in the container with measurement instructions and also sent to the RAN (i.e., the gNB in NR). For the communication between the gNB and the UE, the QoE reference is replaced by a shorter identifier denoted as measConfigAppLayerId, which is locally unique within a UE (i.e., there is a one-to-one mapping between a measConfigAppLayerId and a QoE reference for each QoE configuration provided to a UE. The measConfigAppLayerId is stored in the UE Access Stratum and also forwarded in an AT Command (which is the type of instructions used in the communication between the UE's modem part and the UE's application layer) together with the service type indication and the container with the measurement instructions.

Reports with collected QoE measurement results (QoE reports) are sent from the UE application layer to the UE Access Stratum, which forwards them to the RAN, which forwards them to the MCE. These QoE measurement results are placed in a “container”, which is uninterpretable for the UE Access Stratum and the RAN. QoE reporting can be configured to be periodic or only sent at the end of an application session. Furthermore, the RAN can instruct the UE to pause QoE reporting, e.g., in case the cell/gNB is in a state of overload.

The RAN is not aware of when an application session with an associated QoE measurement session is ongoing, and the UE Access Stratum is also not automatically aware of this. To alleviate this session start/stop indications will be introduced, which will be sent from the application layer in the UE to the UE AS and from the UE AS to the RAN. A session stop indication may be explicit or may be implicit in the form of a QoE report sent when the application session and the associated QoE measurement session are concluded.

The RAN may decide to release a QoE configuration in a UE at any time, as an implementation-based decision. Typically, it is done when the UE has moved outside an area configured for the QoE measurements, which as previously mentioned is commonly referred to as the area scope.

One opportunity provided by legacy solutions is also to be able to keep the QoE measurement for the whole session, even during a handover situation. It is also discussed to let the UE continue with the QoE measurements on an ongoing application session until the application session ends, even if the UE in the meantime moves out of the configured area scope.

### RAN Visible QoE (RVQoE)

An extension of the QoE framework, which has been studied for 3GPP release 17 and which is currently being specified in 3GPP, is the concept of RAN visible QoE (RVQoE). The regular QoE reports are intended for the MCE, which is an entity outside the RAN, e.g., a part of the OAM system, and the RAN cannot read the QoE reports (at least not according to specification, although gNB/eNB implementations are not prevented from doing so). In contrast, reported RVQoE metrics are intended for the RAN and are delivered to the RAN in a format that the RAN understands. The RVQOE metrics are derived from the regular QoE metrics, collected and compiled in reports by the UE application layer and delivered to the RAN, so that the RAN may use the reports for various types of optimizations. As an example, when the RAN receives RVQoE reports during an ongoing application session, the RAN can perform adaptive actions to impact the QoE of the concerned application session while the application session is ongoing, such as change various parameters related to the scheduling of the UE and the data flows related to the application session.

### AT Commands

AT commands are used for communication between the AS (radio) layer and the application layer in the UE. The AT commands are defined in 3GPP TS 27.007 version 17.3.0.

### QoE Measurement in Legacy Systems

### QoE Measurement in UMTS Terrestrial Radio Access Network (UTRAN)

### UTRAN—Application Layer Measurement Capabilities

According to 3GPP TS 25.331, UTRAN can request the UE (using a UE Capability Enquiry RRC message) to report its capability, as shown in Error! Reference source not found., which illustrates a UE capability enquiry procedure in UTRAN.

In response, the UE can provide information about its capability using the UE Capability Information RRC message as shown in Error! Reference source not found., which illustrates the transmission of UE capability information in UTRAN.

The UE can indicate support for QoE measurement and reporting in the UE Capability Information message. The relevant indications are included in the “Measurement capability” information element (IE), which in turn is included in the “UE radio access capability” IE, which is included in the UE Capability Information message. The relevant definitions are copied from 3GPP TS 25.331 version 16.1.0 below.

The UE Capability Information message:

| Information | | | | |
|---|---|---|---|---|
| Element/ | | | Type and | Semantics |
| Group name | Need | Multi | reference | description |
| Message Type | MP | | Message | |
| | | | Type | |
| UE information | | | | |
| elements | | | | |
| RRC transaction | OP | | RRC | |
| identifier | | | transaction | |
| | | | identifier | |
| | | | 10.3.3.36 | |
| Integrity check info | CH | | Integrity | Integrity check info |
| | | | check info | is included if |
| | | | 10.3.3.16 | integrity protection |
| | | | | is applied |
| UE radio access | OP | | UE radio | |
| capability | | | access | |
| | | | capability | |
| | | | 10.3.3.42 | |
| UE radio access | OP | | UE radio | |
| capability extension | | | access | |
| | | | capability | |
| | | | extension | |
| | | | 10.3.3.42a | |
| Other information | | | | |
| elements | | | | |
| UE system specific | OP | 1 to | | |
| capability | | <maxInterSysMessages> | | |
| >Inter-RAT UE radio | MP | | Inter-RAT | |
| access capability | | | UE radio | |
| | | | access | |
| | | | capability | |
| | | | 10.3.8.7 | |

The “UE radio access capability” IE:

| | | | | | |
|---|---|---|---|---|---|
| Information | | | | | |
| Element/ | | | Type and | Semantics | |
| Group name | Need | Multi | reference | description | Version |

.
.
.

| | | |
|---|---|---|
| Measurement | OP | Measurement |
| capability | | capability |
| | | 10.3.3.21 |

.
.
.

The “Measurement capability” IE:

| | | | | | |
|---|---|---|---|---|---|
| Information | | | | | |
| Element/ | | | Type and | Semantics | |
| Group name | Need | Multi | reference | description | Version |

.
.
.

| | | | | |
|---|---|---|---|---|
| QoE Measurement | CV-not_{—} | Enumerated | TRUE means | REL-14 |
| Collection for | iRAT_HoInfo | (TRUE) | that the UE | |
| streaming services | | | supports QoE | |
| | | | Measurement | |
| | | | Collection for | |
| | | | streaming | |
| | | | services. | |
| QoE Measurement | CV-not_{—} | Enumerated | TRUE means | REL-15 |
| Collection for | iRAT_HoInfo | (TRUE) | that the UE | |
| MTSI services | | | supports QoE | |
| | | | Measurement | |
| | | | Collection for | |
| | | | MTSI services. | |

.
.
.

### UTRAN—OoE Measurement Configuration—RRC Signaling

To configure QoE measurement in the UE, the UTRAN can send a Measurement Control RRC message containing the “Application layer measurement configuration” IE. FIG. 3 illustrates a measurement control procedure in a normal UTRAN case.
The relevant definitions are copied from 3GPP TS 25.331 version 16.1.0 below.

The Measurement Control message:

| | | | | | |
|---|---|---|---|---|---|
| Information | | | | | |
| Element/ | | | Type and | Semantics | |
| Group name | Need | Multi | reference | description | Version |

.
.
.

| | | |
|---|---|---|
| >Application layer | Application | REL-14 |
| measurement | layer | |
| configuration | measurement | |
| | configuration | |
| | 10.3.7.143 | |

.
.
.

The “Application layer measurement configuration” IE:

| | | | | | |
|---|---|---|---|---|---|
| Information | | | | | |
| Element/ | | | Type and | Semantics | |
| Group name | Need | Multi | reference | description | Version |

| | | | |
|---|---|---|---|
| Container for | MP | Octet string | REL-14 |
| application | | (1..1000) | |
| layer | | | |
| measurement | | | |
| configuration | | | |
| Service type | MP | Enumerated | REL-15 |
| | | (QoEStreaming, | |
| | | QoEMTSI) | |

### UTRAN—QoE Measurement Reporting—RRC Signaling

The UE can send QoE measurement results via UTRAN to the Collecting Entity using the “Measurement Report” RRC message including the “Application layer measurement reporting” IE. FIG. 4 illustrates a measurement report procedure in a normal UTRAN case.

The UE may also perform Cell Update to indicate that an application layer measurement report is available in the UE.

SRB4 shall be used for the Measurement Report message carrying the “Application layer measurement reporting” IE.

The relevant definitions are copied from 3GPP TS 25.331 version 16.1.0 below.

The Measurement Report message:

| | | | | | |
|---|---|---|---|---|---|
| Information | | | | | |
| Element/ | | | Type and | Semantics | |
| Group name | Need | Multi | reference | description | Version |

.
.
.

| | | | |
|---|---|---|---|
| Application layer | OP | Application | REL-14 |
| measurement | | layer | |
| reporting | | measurement | |
| | | reporting | |
| | | 10.3.7.144 | |

The “Application layer measurement reporting” IE:

| | | | | | |
|---|---|---|---|---|---|
| Information | | | | | |
| Element/ | | | Type and | Semantics | |
| Group name | Need | Multi | reference | description | Version |

| | | | |
|---|---|---|---|
| Container for | MP | Octet string | REL-14 |
| application | | (1..8000) | |
| layer | | | |
| measurement | | | |
| reporting | | | |
| Service type | MP | Enumerated | REL-15 |
| | | (QoEStreaming, | |
| | | QoEMTSI) | |

The Cell Update message:

| | | | | | |
|---|---|---|---|---|---|
| Information | | | | | |
| Element/ | | | Type and | Semantics | |
| Group name | Need | Multi | reference | description | Version |

.
.
.

| | | |
|---|---|---|
| Cell update | MP | Cell update |
| cause | | cause 10.3.3.3 |

.
.
.

| | | | | |
|---|---|---|---|---|
| Logged Meas | OP | Enumerated | Indicates | REL-10 |
| Available | | (TRUE) | the UE has | |
| | | | logged | |
| | | | measurements | |
| | | | to report to | |
| | | | the network | |

.
.
.

The “Cell update cause” IE:

| | | | | | |
|---|---|---|---|---|---|
| Information | | | | | |
| Element/ | | | Type and | Semantics | |
| Group name | Need | Multi | reference | description | Version |

| | | | | |
|---|---|---|---|---|
| Cell update | MP | Enumerated | | |
| cause | | (cell reselection, | | |
| | | periodical cell | | |
| | | update, uplink | | |
| | | data transmission, | | |
| | | paging response, | | |
| | | re-entered | | |
| | | service area, | | |
| | | radio link | | |
| | | failure, RLC | | |
| | | unrecoverable | | |
| | | error, | | |
| | | cellUpdateCause - | | |
| | | ext) | | |
| Cell update | OP | Enumerated | | REL-6 |
| cause Ext | | (MBMS | | |
| | | reception, | | |
| | | MBMS ptp RB | | |
| | | request, dummy, | | |
| | | cellUpdateCause - | | |
| | | ext2) | | |
| Cell update | OP | Enumerated | Three spare | REL-14 |
| cause Ext2 | | (application | values are | |
| | | layer | needed. | |
| | | measurement | | |
| | | report available) | | |

### QoE Measurement in Evolved UTRAN (E-UTRAN)

### E-UTRAN—Application Layer Measurement Capabilities

For E-UTRAN, the UE capability transfer is used to transfer UE radio access capability information from the UE to E-UTRAN. FIG. 5 illustrates a UE capability transfer procedure involving E-UTRAN.

The UE-EUTRA-Capability IE is used to convey the E-UTRA UE Radio Access Capability Parameters and the Feature Group Indicators for mandatory features to the network.

In the response message “UECapabilityInformation”, the UE can include the “UE-EUTRA-Capability” IE. The “UE-EUTRA-Capability” IE may include the “UE-EUTRA-Capability-v1530-IEs” IE which can be used by the UE to indicate whether the UE supports QoE Measurement Collection for streaming services and/or MTSI services. The relevant ASN.1 code in the ASN.1 definition for UE-EUTRA-Capability IE is indicated below (where most of the ASN. 1 code in the UE-EUTRA-Capability IE definition is omitted for clarity).

```
-- ASN1START
  :
  :
  :
  :
UE-EUTRA-Capability-v1530-IEs ::= SEQUENCE {
```

| | |
|---|---|
| measParameters-v1530 | MeasParameters-v1530 |

OPTIONAL,

| | |
|---|---|
| otherParameters-v1530 | Other-Parameters-v1530 |

OPTIONAL,

| | |
|---|---|
| neighCellSI-AcquisitionParameters-v1530 | NeighCellSI-AcquisitionParameters- |

| | |
|---|---|
| v1530 | OPTIONAL, |

| | |
|---|---|
| mac-Parameters-v1530 | MAC-Parameters-v1530 |

OPTIONAL,

| | |
|---|---|
| phyLayerParameters-v1530 | PhyLayerParameters-v1530 |

OPTIONAL,

| | |
|---|---|
| rf-Parameters-v1530 | RF-Parameters-v1530 |

OPTIONAL,

| | |
|---|---|
| pdcp-Parameters-v1530 | PDCP-Parameters-v1530 |

OPTIONAL,

| | |
|---|---|
| ue-CategoryDL-v1530 | INTEGER (22..26) |

OPTIONAL,

| | |
|---|---|
| ue-BasedNetwPerfMeasParameters-v1530 | UE-BasedNetwPerfMeasParameters- |

| | |
|---|---|
| v1530 | OPTIONAL, |

| | |
|---|---|
| rlc-Parameters-v1530 | RLC-Parameters-v1530 |

OPTIONAL,

| | |
|---|---|
| sl-Parameters-v1530 | SL-Parameters-v1530 |

OPTIONAL,

| | |
|---|---|
| extendedNumberOfDRBs-r15 | ENUMERATED {supported} |

OPTIONAL,

| | |
|---|---|
| reducedCP-Latency-r15 | ENUMERATED {supported} |

OPTIONAL,

| | |
|---|---|
| laa-Parameters-v1530 | LAA-Parameters-v1530 |

OPTIONAL,

| | |
|---|---|
| ue-CategoryUL-v1530 | INTEGER (22..26) |

OPTIONAL,

| | |
|---|---|
| fdd-Add-UE-EUTRA-Capabilities-v1530 | UE-EUTRA-CapabilityAddXDD- |

| | |
|---|---|
| Mode-v1530 | OPTIONAL, |

| | |
|---|---|
| tdd-Add-UE-EUTRA-Capabilities-v1530 | UE-EUTRA-CapabilityAddXDD- |

| | |
|---|---|
| Mode-v1530 | OPTIONAL, |

| | |
|---|---|
| nonCriticalExtension | UE-EUTRA-Capability-v1540-IEs |

OPTIONAL,

```
}
  :
  :
  :
  :
```

| | |
|---|---|
| MeasParameters-v1530 ::= | SEQUENCE { |
| qoe-MeasReport-r15 | ENUMERATED {supported} |

OPTIONAL,

| | |
|---|---|
| qoe-MTSI-MeasReport-r15 | ENUMERATED {supported} |

OPTIONAL,

| | |
|---|---|
| ca-IdleModeMeasurements-r15 | ENUMERATED {supported} |

OPTIONAL,

| | |
|---|---|
| ca-IdleModeValidityArea-r15 | ENUMERATED {supported} |

OPTIONAL,

| | |
|---|---|
| heightMeas-r15 | ENUMERATED {supported} |

OPTIONAL,

| | |
|---|---|
| multipleCellsMeasExtension-r15 | ENUMERATED {supported} |

OPTIONAL

```
}
  :
  :
  :
  :
-- ASN1STOP
```

| | FDD/ |
|---|---|
| UE-EUTRA-Capability | TDD |
| field descriptions | diff |
| . | — |
| . | |
| . | |
| qoe-MeasReport | — |
| Indicates whether the UE supports | |
| QoE Measurement Collection for | |
| streaming services. | |
| qoe-MTSI-MeasReport | |
| Indicates whether the UE supports | |
| QoE Measurement Collection for | |
| MTSI services. | |
| . | — |
| . | |
| . | |

### E-UTRAN—QoE Measurement Configuration Setup and Release—RRC Signaling

The RRCConnectionReconfiguration message is used to reconfigure the UE to setup or release the UE for Application Layer measurements. This is signaled in the measConfigAppLayer-r15 IE within the OtherConfig IE.

The setup includes the transparent container measConfigAppLayerContainer IE which specifies the QoE measurement configuration for the application of interest and the service Type IE which indicates the Application (or service) for which the QoE measurements are being configured. Supported services are streaming and MTSI.

The relevant parts of the ASN.1 code and field descriptions for the OtherConfig IE is copied from 3GPP TS 36.331 version 16.6.0 below (with the fields/parameters that are irrelevant in the context of QoE omitted for clarity).

```
-- ASN1START
OtherConfig-r9 ::= SEQUENCE {
    :
    :
    :
    :
```

| [[ measConfigAppLayer-r15 | | CHOICE{ |
|---|---|---|
| | release | NULL, |
| | setup | SEQUENCE{ |
| | measConfigAppLayerContainer-r15 | OCTET STRING |

(SIZE(1..1000)),

| | |
|---|---|
| serviceType-r15 | ENUMERATED {qoe, |

qoemtsi, spare6,

| | |
|---|---|
| | spare5, spare4, spare3, |
| | spare2, spare1} |
| | } |
| } | OPTIONAL, -- Need ON |

```
    :
    :
    :
    :
}
    :
    :
    :
-- ASN1STOP
```

OtherConfig field descriptions
.
.
.
measConfigAppLayerContainer
The field contains configuration of application
layer measurements, see Annex L (normative) in
TS 26.247 [90] and clause 16.5 in TS 26.114 [99].
.
.
.

The following is the procedural text related to the OtherConfig IE (i.e. when the UE receives an RR (ConnectionReconfiguration message including an OtherConfig IE) and QoE measurement configuration.

| | | The UE shall: |
|---|---|---|
| | : | |
| | : | |
| | : | |
| 1> | if the received otherConfig includes the measConfigAppLayer: | |
| 2> | | if measConfigAppLayer is set to setup: |
| | 3> | forward measConfigAppLayerContainer to upper layers considering the |

serviceType;

| | |
|---|---|
| 3> | consider itself to be configured to send application layer measurement report in |

accordance with 5.6.19;

| 2> | | else: |
|---|---|---|
| | 3> | inform upper layers to clear the stored application layer measurement |

configuration;

| | |
|---|---|
| 3> | discard received application layer measurement report information from upper |

layers;

3> consider itself not to be configured to send application layer

measurement report.

### E-UTRAN—Application Layer Measurement Reporting

The purpose of the “Application layer measurement reporting” procedure described in 3GPP TS 36.331 version 16.6.0 and shown below is to transfer the application layer measurement report to E-UTRAN, so that the E-UTRAN can forward the report to the O&M system, e.g. to a Measurement Collector Entity (MCE) or a Trace Collector Entity (TCE). FIG. 6 illustrates application layer measurement reporting in E-UTRAN.

A UE capable of application layer measurement reporting in RRC_CONNECTED state may initiate the procedure when configured with application layer measurement, i.e. when the measConfigAppLayer IE has been configured by E-UTRAN. For this purpose, the UE uses the MeasReportAppLayer RRC message, which contains the measReportAppLayerContainer IE and the service Type IE.

According to 3GPP TS 36.331 version 16.6.0, upon initiating the application layer measurement reporting procedure, the UE shall:

| | |
|---|---|
| 1> | if configured with application layer measurement, and SRB4 is configured, and the UE |

has received application layer measurement report information from upper layers:

| | |
|---|---|
| 2> | set the measReportAppLayerContainer in the MeasReportAppLayer message to |

the value of the application layer measurement report information;

| | |
|---|---|
| 2> | set the serviceType in the MeasReportAppLayer message to the type of the |

application layer measurement report information;

| | |
|---|---|
| 2> | submit the MeasReportAppLayer message to lower layers for transmission via |

SRB4.

In ASN.1 code (with associated field descriptions), the MasReportAppLayer message is defined as follows in 3GPP TS 36.331 version 16.6.0:

-- ASN1START

| | |
|---|---|
| MeasReportAppLayer-r15 ::= | SEQUENCE { |
| criticalExtensions | CHOICE { |
| measReportAppLayer-r15 | MeasReportAppLayer-r15-IEs, |
| criticalExtensionsFuture | SEQUENCE { } |

}
}

| | |
|---|---|
| MeasReportAppLayer-r15-IEs ::= | SEQUENCE { |
| measReportAppLayerContainer-r15 | OCTET STRING (SIZE(1..8000)) |

OPTIONAL,

| | |
|---|---|
| serviceType-r15 | ENUMERATED {qoe, qoemtsi, spare6, |

spare5,
spare4, spare3, spare2,

| | |
|---|---|
| spare 1} | OPTIONAL, |
| nonCriticalExtension | MeasReportAppLayer-v1590-IEs |

OPTIONAL
}

| | |
|---|---|
| MeasReportAppLayer-v1590-IEs ::= | SEQUENCE { |
| lateNonCriticalExtension | OCTET STRING |

OPTIONAL,

| | |
|---|---|
| nonCriticalExtension | SEQUENCE { } |

OPTIONAL
}
-- ASN1STOP

MeasReportAppLayer field descriptions
measReportAppLayerContainer
The field contains container of application layer
measurements, see Annex L (normative) in
TS 26.247 [90] and clause 16.5 in
TS 26.114 [99].
serviceType
Indicates the type of application layer
measurement. Value qoe indicates Quality of
Experience Measurement Collection for
streaming services, value qoemtsi indicates
Quality of Experience Measurement Collection
for MTSI.

### UE Application Layer Measurement Configuration

For signaling based QoE configuration, the configuration is signaled to the RAN (eNB) from the MME using the control plane protocol for the S1 interface, i.e. S1AP, which is specified in 3GPP TS 36.413 version 16.7.0.

The “UE Application layer measurement configuration” IE defines configuration information for the QoE Measurement Collection (QMC) function. It is described in section 9.2.1.128 of 3GPP TS 36.413 version 16.7.0 as follows (note that this IE is included in the Trace Activation IE, which also, among other parameters, includes the Trace Collection Entity IP Address IE):

| IE/Group | | | IE type and | Semantics | | Assigned |
|---|---|---|---|---|---|---|
| Name | Presence | Range | reference | description | Criticality | Criticality |
| Container | M | | Octet string | Indicates | — | — |
| for | | | (1 . . . 1000) | application | | |
| application | | | | layer | | |
| layer | | | | measurement | | |
| measurement | | | | configuration, | | |
| configuration | | | | see Annex | | |
| | | | | L in [43]. | | |
| CHOICE | M | | | | — | — |
| Area | | | | | | |
| Scope of | | | | | | |
| QMC | | | | | | |
| >Cell | | | | | | — |
| based | | | | | | |
| >>Cell ID | | 1 . . . | | | | — |
| List for | | <maxnoofCellIDforQMC> | | | | |
| QMC | | | | | | |
| >>>E-CGI | M | | 9.2.1.38 | | — | — |
| >TA based | | | | | | — |
| >>TA List | | 1 . . . | | | | — |
| for QMC | | <maxnoofTAforQMC> | | | | |
| >>>TAC | M | | 9.2.3.7 | The TAI is | — | — |
| | | | | derived using | | |
| | | | | the current | | |
| | | | | serving PLMN. | | |
| >TAI | | | | | — | — |
| based | | | | | | |
| >>TAI | | 1 . . . | | | — | — |
| List for | | <maxnoofTAforQMC> | | | | |
| QMC | | | | | | |
| >>>TAI | M | | 9.2.3.16 | | — | — |
| >PLMN | | | | | | — |
| area based | | | | | | |
| >>PLMN | | 1 . . . | | | | — |
| List for | | <maxnoofPLMNforQMC> | | | | |
| QMC | | | | | | |
| >>>PLMN | M | | 9.2.3.8 | | — | — |
| Identity | | | | | | |
| Service | M | | ENUMERATED | This IE | — | — |
| Type | | | (QMC for | indicates the | | |
| | | | streaming | service type | | |
| | | | service, | of UE | | |
| | | | QMC for | application | | |
| | | | MTSI | layer | | |
| | | | service, . . .) | measurements. | | |

| Range bound | Explanation |
|---|---|
| maxnoofCellIDforQMC | Maximum no. of Cell ID subject |
| | for QMC scope. Value is 32. |
| maxnoofTAforQMC | Maximum no. of TA subject for |
| | QMC scope. Value is 8. |
| maxnoofPLMNforQMC | Maximum no. of PLMNs in the |
| | PLMN list for QMC scope. |
| | Value is 16. |

### Area Scope for QoE Measurements

According to 3GPP TS 28.405 version 16.0.0, the area scope parameter defines the area in terms of cells or Tracking Area/Routing Area/Location Area where the QMC shall take place. If the parameter is not present, the QMC shall be done throughout the Public Land Mobile Network (PLMN) specified in PLMN target.

The area scope parameter in UMTS is either:
A list of cells, identified by Cell Global Identity (CGI). Maximum 32 CGI can be defined.
A list of Routing Area, identified by Routing Area Identification (RAI). Maximum of 8 RAIs can be defined.
A list of Location Area, identified by Location Area Identification (LAI). Maximum of 8 LAIs can be defined.

The area scope parameter in LTE is either:
A list of cells, identified by E-UTRAN-CGI. Maximum 32 CGI can be defined.
A list of Tracking Area, identified by Tracking Area Code (TAC). Maximum of 8 TAC can be defined.

For NR, the area scope parameter will be either:
A list of cells, or
A list of tracking areas.

The parameter is mandatory if area based QMC is requested.

### RRC_INACTIVE State

In 5G/NR, a UE may be in either of three different RRC states: RRC_CONNECTED state, RRC_INACTIVE state and RRC_IDLE state. RRC_CONNECTED state is the state normally used when the UE is actively communicating. RRC_INACTIVE state and RRC_IDLE state are designed to allow the UE to save energy compared to when the UE is in RRC_CONNECTED state.

RRC_IDLE state is the state in which the UE consumes the least energy (and the gNB saves resources by deleting the UE's state information, also known as the UE context), but it comes at the cost of comparatively long network access time (e.g., transition to RRC_CONNECTED state).

RRC_INACTIVE state has properties that put it in between the RRC_CONNECTED state and RRC_IDLE state.

The purpose of the RRC_INACTIVE state is to reduce the signaling overhead over the radio and network interface and to improve the UE access latency (compared to RRC_IDLE state) as well as the UE energy consumption. In this state, the Core Network (CN) still regards the UE as connected, thus the CN-RAN connection for the UE is kept active although the RRC connection between the gNB and the UE is suspended. The gNB which maintains the connection to the CN while the UE is in RRC_INACTIVE state is called the Anchor gNB. In order to reduce radio interface signaling at connection establishment, the UE context information is kept in the UE and in the Anchor gNB, which enables the UE to resume its RRC connection when it is paged or has uplink (UL) data or signaling to send. When the CN has user data or control data to send to the UE, the data is sent to the Anchor gNB which then initiates paging of the UE (also known as RAN initiated paging).

In RRC_INACTIVE state, the UE can move around in a UE specific RAN Notification Area (RNA) without informing the network of its location within the RNA. When the UE leaves its configured RNA, the UE informs the network using RNA Update signaling in the form of an RR (ResumeRequest message with the resumeCause IE set to “rna-Update”. If too long time elapses without communication between the UE and the network, the UE sends a periodic RNA Update (i.e. an RRCResumeRequest message with the resumeCause IE set to “rna-Update”) to the network, even if it has not left its configured RNA.

The gNB configures the UE's RNA when the gNB releases the UE from RRC_CONNECTED state to RRC_INACTIVE state, using an RRCRelease message. There are three different alternatives for how to configure a RNA for a UE:
A list of cells. The UE is provided with a list of (one or more) global cell IDs of the cells constituting the RNA.
A list of RAN Areas. The UE is provided a list of (one or more) RAN Area IDs, where a RAN Area ID consists of a RAN Area Code (RANAC) combined with a Tracking Area Code and a PLMN ID (i.e. the RANAC is unique within a Tracking Area). To enable RNA configuration using a list of RAN Areas, every cell should broadcast a RAN Area Code (which could optionally be absent in case the network does not use RAN Area based RNA configuration). A RAN Area consists of a subset (or all) of the cells of one Tracking Area.
A list of Tracking Areas. The UE is provided a list of (one or more) Tracking Area IDs, where a Tracking Area ID consists of a Tracking Area Code (TAC) combined with a PLMN ID.

A UE's RNA should not include areas outside the list of Tracking Areas the CN has configured for the UE, since crossing of this border would trigger the UE to send a Registration Request Non-Access Stratum (NAS) message to the CN with the “5GS registration type” IE set to “mobility registration updating” (i.e. the procedure referred to as Tracking Area Update in LTE).

The RAN may use either of the above configuration alternatives when configuring a RNA for a UE, and it may use different configuration methods for different UEs as well as for the same UE at different times, but it cannot mix different configuration alternatives in the same RNA configuration for a certain UE at the same time.

Upon an RNA Update (or other contact between the UE and the network), the RAN may configure a new RNA for the UE (e.g. if the UE has moved to a new cell) and if the UE has moved to a new gNB, the UE's context in the RAN is fetched from the old Anchor gNB to the new gNB. This is done using the XnAP messages RETRIEVE UE CONTEXT REQUEST and RETRIEVE UE CONTEXT RESPONSE. In addition, the RAN-CN connection for the UE is moved from the old Anchor gNB to the new gNB, which then becomes the new Anchor gNB. This is done using the NG Application Protocol (NGAP) messages PATH SWITCH REQUEST and PATH SWITCH REQUEST ACKNOWLEDGE.

When the RAN switches (i.e. releases) a UE from RRC_CONNECTED to RRC_INACTIVE state, the serving gNB (which becomes the Anchor gNB) allocates an identity referred to as the I-RNTI to the UE. The I-RNTI serves to identify both the Anchor gNB and the UE's context within the Anchor gNB when the UE's context is fetched from an old Anchor gNB to a new gNB.

When the UE wants to transit from the RRC_INACTIVE state to the RRC_CONNECTED state, due to reception of a page or due to arrival of pending UL data (i.e. data originating in the UE and put in an UL transmission buffer in the UE), the UE sends a request to resume the RRC connection (including the suspended radio bearers) containing its I-RNTI (this is the RR (ResumeRequest message). The gNB receiving the request uses the included I-RNTI to fetch the UE's context from the old Anchor gNB (also known as “last serving gNB”), after which the RRC connection can be resumed. The new gNB then completes the resumption of the RRC connection (by sending an RR (Resume message from the new gNB to the UE, which the UE responds to with an RR (ResumeComplete message), and the UE context in the old Anchor gNB (last serving gNB) is deleted.

A UE in RRC_INACTIVE state is said to be “camping” on a cell in which it monitors relevant downlink (DL) control signals, such as synchronization signals, system information and paging. An RRC_INACTIVE UE is assumed to follow the same cell reselection rules as a UE in RRC_IDLE state. Hence, the cell reselection information provided in the system information, which traditionally is used by UEs in RRC_IDLE state, applies to UEs in RRC_INACTIVE state too. This includes e.g. measurement thresholds, reselection thresholds, hysteresis parameters to avoid “ping-pong” reselection and potential cell-specific offsets. In addition, to control potential inter-frequency and/or inter-Radio Access Technology (RAT) cell reselection, the cell reselection related system information typically also contains frequency priorities and/or RAT priorities.

There currently exist certain challenge(s). A QoE measurement configuration is retained in the UE when the UE is in RRC_INACTIVE state. This means that an application session initiated when the UE is in RRC_INACTIVE state may be subject to QoE measurement. Since an application session with an associated QoE measurement configuration also may be initiated when the UE is in RRC_CONNECTED state, this means that an application session with an associated QoE measurement configuration may be initiated in different RRC states (i.e. it may be initiated at least in RRC_CONNECTED and RRC_INACTIVE state, and in future 3GPP releases possibly also in RRC_IDLE state, e.g. when QoE measurements on MBS sessions are specified). The RRC state the UE is in when the application session is initiated will impact the initial performance of the application and this may be reflected in the QoE measurement data, and this will make consistent analysis of the QoE measurement results more difficult. A typical example is that when a streaming (e.g. DASH) application is initiated in RRC_INACTIVE state, the initial playout delay (which is one of the QoE metrics for a streaming application) will (typically, or on average) be significantly longer than if the application session is initiated in RRC_CONNECTED state.

### SUMMARY

Certain aspects of the disclosure and their embodiments may provide solutions to these or other challenges. The general means to address the problem(s) described above is that the QoE report may be extended with, or complemented with, information about the state (e.g. RRC state) the UE was in when the application session and/or the QoE measurement session the QoE report pertains to was initiated. This UE state is henceforth also referred to as the “initial state”. This solution principle may also be applied to RVQoE measurements and RVQOE measurement reporting.

This is useful especially when the UE is in RRC_INACTIVE state when the application session is initiated (which may be a common case). In this situation, the initiation of the application session triggers the UE to initiate the RRC resume procedure to transit to the RRC_CONNECTED state (e.g. because the application generates data to be transmitted).

The additional state information may inform the entity analyzing the reported QoE measurement data (e.g. an MCE or an entity to which the MCE forwards the reported QoE measurement data) of which state the UE was in when the concerned application session (i.e. the application session the reported QoE measurement data pertains to, i.e. was collected from) was initiated. This in turn may facilitate the analyzing entity to properly judge a reported performance metric which may be impacted by the state the UE was in when the application session was initiated, e.g. the initial playout delay of a streaming application. Similarly, a RAN node receiving an RVQoE report may benefit from the state information when analyzing the reported RVQoE metrics and determining any appropriate actions.

To further facilitate such an analysis, in some embodiments, the QoE report is enriched with information about the delay incurred by the RRC resume procedure (which may then be incorporated in the reported initial playout delay), where this delay information may be reported together with the first QoE report pertaining to a certain application session.

The core essence of the solution is to enrich the first QoE report pertaining to an application session with information about the state, e.g. RRC state, the UE was in when the application session was initiated (at least when this initial state was the RRC_INACTIVE state and the initiation of the application session triggered the UE to initiate the RRC resume procedure). The state information may be included in the QoE report (e.g. if the state information is determined by the UE application layer) or may be reported together with (but outside) the QoE report (e.g. if the state information is determined by the UE AS or a RAN node, such as a gNB or an eNB).

The state information may be further enriched with information about the delay incurred by the RRC resume procedure that was triggered by the initiation of the application session.

In one aspect, a method is performed by a UE for reporting QoE, information. The method comprises transmitting, to a network node of a communications network, a QoE measurement report comprising QoE measurement data associated with an application session between the UE and the communications network. The method further comprises transmitting, to the network node, an indication of a connectivity state of the UE with respect to the communications network when the application session was initiated.

In a second aspect, a method is performed by a RAN node of a communications network for reporting UE quality of experience QoE information. The method comprises transmitting, to a network node of the communications network, a QoE measurement report comprising QoE measurement data associated with an application session between the UE and the communications network. The method further comprises transmitting, to the network node, an indication of a connectivity state of the UE with respect to the communications network when the application session was initiated.

In a third aspect, a method is performed by a network node of a communications network for receiving UE QoE information. The method comprises receiving a QoE measurement report comprising QoE measurement data associated with an application session between the UE and the communications network. The method further comprises receiving an indication of a connectivity state of the UE with respect to the communications network when the application session was initiated.

Certain embodiments may provide one or more of the following technical advantage(s). The advantage of the proposed solution is that the entity analyzing collected and reported QoE measurement data can better judge the reason for an observed performance of a certain QoE metric, based on knowledge of the RRC state the UE was in when the concerned application session was initiated (as well as knowledge of the delay incurred by the transition from RRC_INACTIVE state to RRC_CONNECTED state triggered by the initiation of the application session). This allows better use of the collected QoE measurement data and facilitates selection of efficient optimizing action.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 is a signalling diagram illustrating a UE capability enquiry procedure;

FIG. 2 is a signalling diagram illustrating the transmission of UE capability information;

FIG. 3 is a signalling diagram illustrating a measurement control procedure;

FIG. 4 is a signalling diagram illustrating a measurement reporting procedure;

FIG. 5 is a signalling diagram illustrating a UE capability transfer procedure;

FIG. 6 is a signalling diagram illustrating an application layer measurement reporting procedure;

FIG. 7 is a schematic flowchart showing a method in accordance with some embodiments;

FIG. 8 is a schematic flowchart showing a method in accordance with some embodiments;

FIG. 9 is a schematic flowchart showing a method in accordance with some embodiments;

FIG. 10 shows an example of a communication system in accordance with some embodiments;

FIG. 11 shows a UE in accordance with some embodiments;

FIG. 12 shows a network node in accordance with some embodiments;

FIG. 13 is a block diagram of a host in accordance with various aspects described herein;

FIG. 14 is a block diagram illustrating a virtualization environment in which functions implemented by some embodiments may be virtualized;

FIG. 15 is a block diagram showing a communication diagram of a host communicating via a network node with a UE over a partially wireless connection in accordance with some embodiments; and

FIG. 16 shows a network node in accordance with further embodiments.

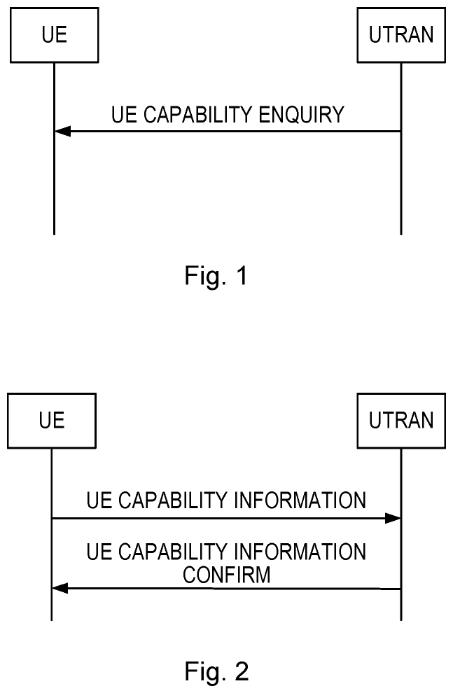

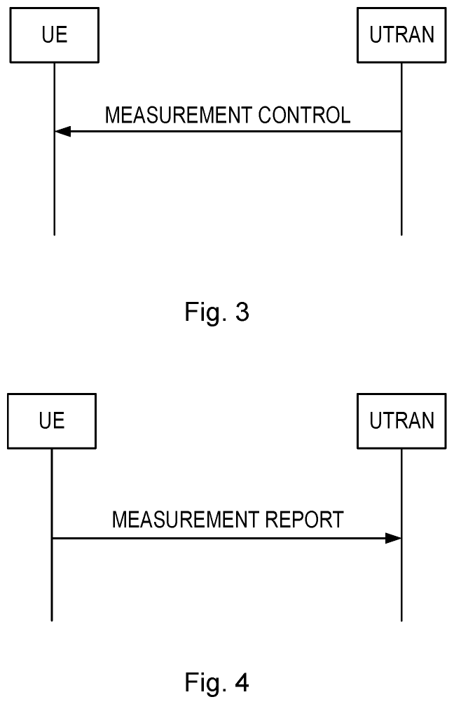

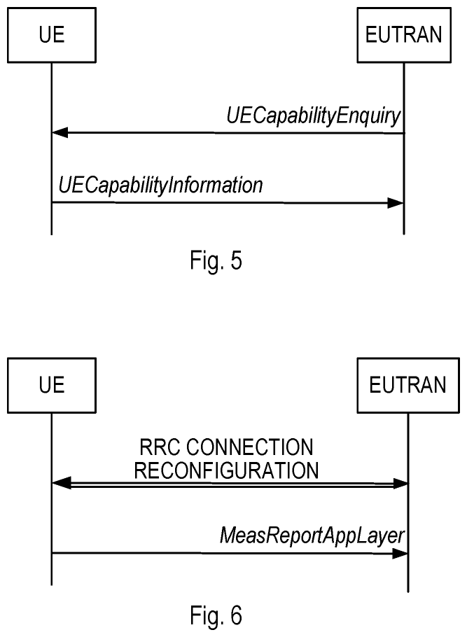

### DETAILED DESCRIPTION

Some of the embodiments contemplated herein will now be described more fully with reference to the accompanying drawings. Embodiments are provided by way of example to convey the scope of the subject matter to those skilled in the art.

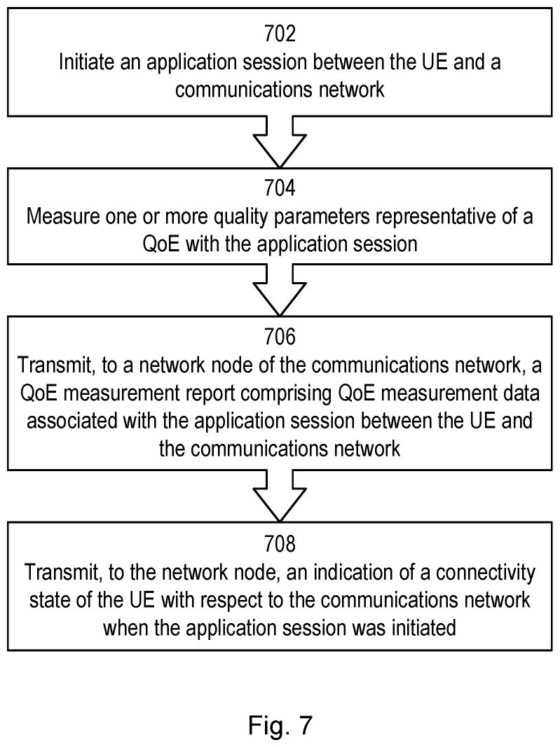

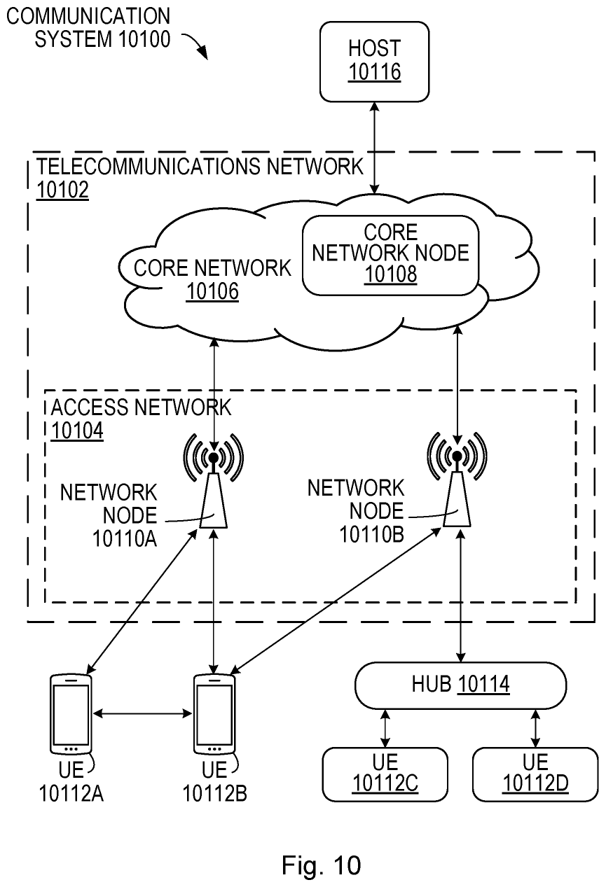

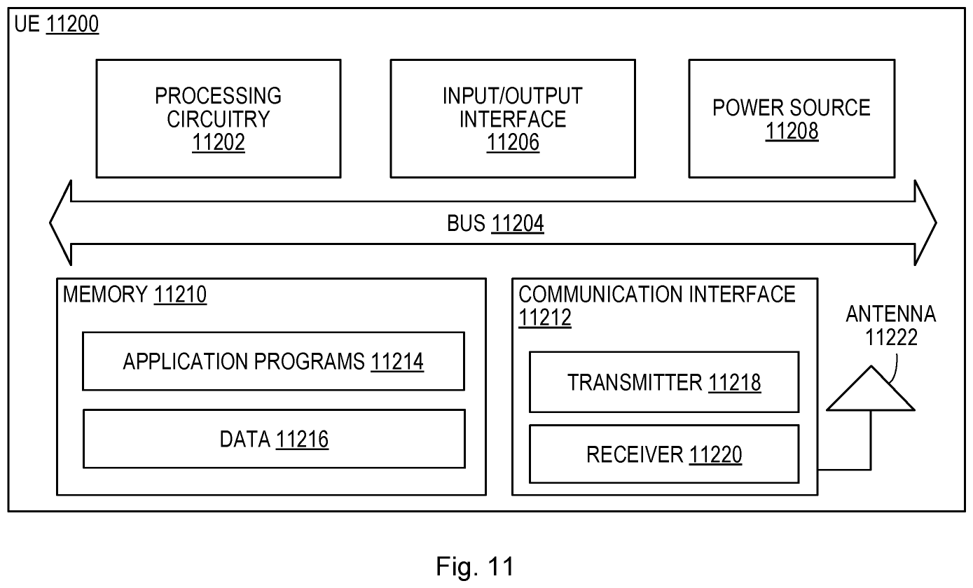

FIG. 7 depicts a method in accordance with particular embodiments. The method of FIG. 7 may be performed by a UE or wireless device (e.g. the UE 1012 or UE 1100 as described later with reference to FIGS. 10 and 11 respectively) for reporting QoE information. In some respects, the method shown in FIG. 7 may correspond to the embodiments discussed in sections 2.1 and 2.2 below. For example, the method shown in FIG. 7 may correspond to steps performed by the UEs discussed in these sections.

The method begins at step 702, with the UE initiating an application session between the UE and a communications network. In step 704, the UE measures one or more quality parameters representative of a QoE associated with the application session. In step 706, the UE transmits, to a network node of the communications network (e.g., a measurement collection entity (MCE) or a RAN node), a QoE measurement report comprising QoE measurement data associated with the application session between the UE and the communications network. For example, the QoE measurement data included in the QoE measurement report may comprise RAN visible QoE measurement data. That is, some (or all) of the QoE measurement data may be visible to the RAN, whilst some (or none) of the QoE measurement data may not be visible to the RAN. In another example, the QoE measurement report may be a RAN visible QoE measurement report containing only RAN visible QoE measurement data. In a further example, some or all of the QoE measurement data may not be visible to the RAN (e.g., the QoE measurement report is not RAN-visible). In some embodiments, the QoE measurement data comprises the one or more quality parameters. In step 708, the UE transmits, to the network node, an indication of a connectivity state of the UE with respect to the communications network when the application session was initiated.

In some embodiments, the indication of the connectivity state of the UE is determined by any one of: an application layer of the UE (for example, via one or more of the methods discussed in section 2.1 below); and an access stratum of the UE (for example, via one or more of the methods discussed in section 2.2 below).

In some embodiments, responsive to the connectivity state of the UE changing from a first connectivity state to a second connectivity state during the application session, the method further comprises transmitting, to the network node, an indication of one or more of: the first connectivity state and the second connectivity state; a time period in which the UE was in the first connectivity state before changing to the second connectivity state; and a timestamp indicating a time at which the connectivity state of the UE changed.

In some embodiments, the connectivity state of the UE comprises one or more of:
a Radio Resource Control (RRC) state;
a Connection Management (CM) state;
a 5G Mobility Management (5GMM) state;
a Mobility Management (MM) state;
a Registration Management (RM) state;
a Registration state;
an Evolved Packet System (EPS) Connection Management (ECM) state; and
an EPS Mobility Management (EMM) state.

In some embodiments, the indication of the connectivity state of the UE is transmitted during the application session. In other embodiments, the indication of the connectivity state of the UE is transmitted after the application session has terminated.

In some embodiments, the indication of the connectivity state of the UE is transmitted in the same transmission as the QoE measurement report. In other embodiments, the indication of the connectivity state of the UE is transmitted in a different transmission to the QoE measurement report.

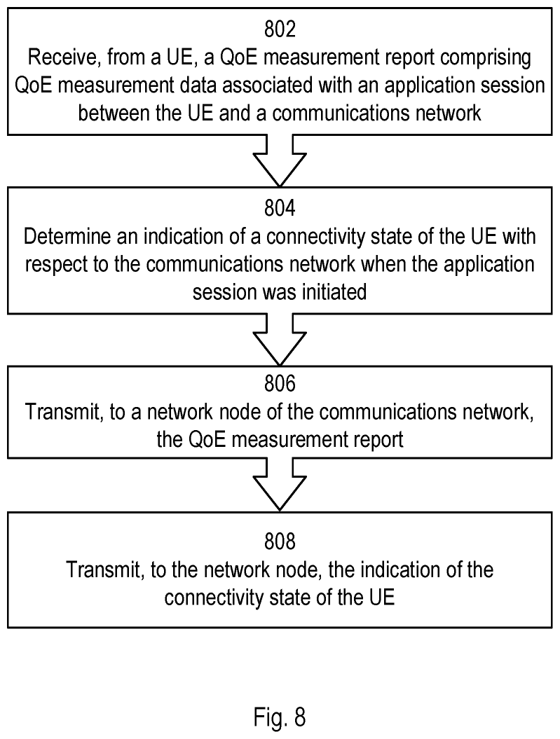

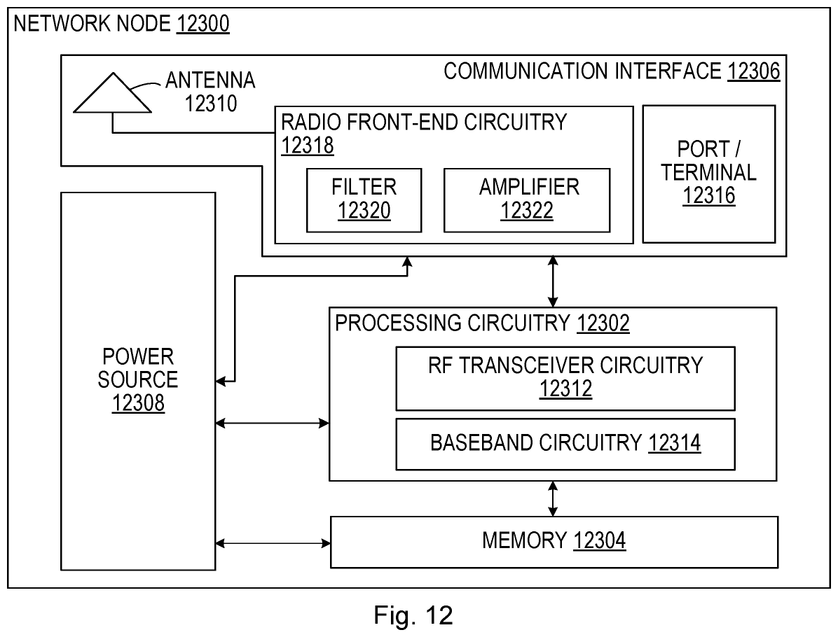

FIG. 8 depicts a method in accordance with particular embodiments. The method of FIG. 8 may be performed by a RAN node (e.g. the network node 1010 or network node 1200 as described later with reference to FIGS. 10 and 12 respectively) of a communications network for reporting UE QoE information. In some respects, the method shown in FIG. 8 may correspond to the embodiments discussed in section 2.3 below. For example, the method shown in FIG. 8 may correspond to steps performed by a node of the RAN discussed in this section.

The method may begin at step 802, with the RAN node receiving, from a UE, a QoE measurement report comprising QoE measurement data associated with an application session between the UE and a communications network. For example, the QoE measurement data included in the QoE measurement report may comprise RAN visible QoE measurement data. That is, some (or all) of the QoE measurement data may be visible to the RAN, whilst some (or none) of the QoE measurement data may not be visible to the RAN. In another example, the QoE measurement report may be a RAN visible QoE measurement report containing only RAN visible QoE measurement data. In a further example, some or all of the QoE measurement data may not be visible to the RAN (e.g., the QoE measurement report is not RAN-visible). In step 804, the RAN node may determine an indication of a connectivity state of the UE with respect to the communications network when the application session was initiated. In step 806, the RAN node transmits, to a network node of the communications network (e.g., a measurement collection entity (MCE)) the QoE measurement report. In step 808, the RAN node transmits, to the network node, the indication of the connectivity state of the UE.

As discussed above, in some embodiments, the RAN node determines the indication of the connectivity state of the UE. This step may be realised, for example, using one or more methods discussed in section 2.3 below. For example, in some embodiments, the determination of the indication of the connectivity state of the UE is based on at least one of: an indication, received from the UE, that the application session has been initiated by the UE; and an indication, received from the UE, that a connection procedure has been initiated by the UE with respect to the communications network.

In some embodiments, responsive to the connectivity state of the UE changing from a first connectivity state to a second connectivity state during the application session, the RAN node transmits, to the network node, an indication of one or more of: the first connectivity state and the second connectivity state; a time period in which the UE was in the first connectivity state before changing to the second connectivity state; and a timestamp indicating a time at which the connectivity state of the UE changed.

In some embodiments, the connectivity state of the UE comprises one or more of:
a Radio Resource Control (RRC) state;
a Connection Management (CM) state;
a 5G Mobility Management (5GMM) state;
a Mobility Management (MM) state;
a Registration Management (RM) state;
a Registration state;
an Evolved Packet System (EPS) Connection Management (ECM) state; and
an EPS Mobility Management (EMM) state.

In some embodiments, the indication of the connectivity state of the UE is transmitted during the application session. In other embodiments, the indication of the connectivity state of the UE is transmitted after the application session has terminated.

In some embodiments, the indication of the connectivity state of the UE is transmitted in the same transmission as the QoE measurement report. In other embodiments, the indication of the connectivity state of the UE is transmitted in a different transmission to the QoE measurement report.

In some embodiments, the RAN node adapts, based on the QoE measurement report and the indication of the connectivity state of the UE, a configuration parameter relating to a transfer of data between the UE and the communications network.

For example, the network node may receive QoE and/or RVQoE reports during an ongoing application session (for example, in some embodiments, the QoE measurement data comprises radio access network (RAN) visible QoE measurement data). The network node may then perform adaptive actions to impact the QoE of the concerned application session while the application session is ongoing, such as change various parameters related to the scheduling of the UE and the data flows related to the application session.

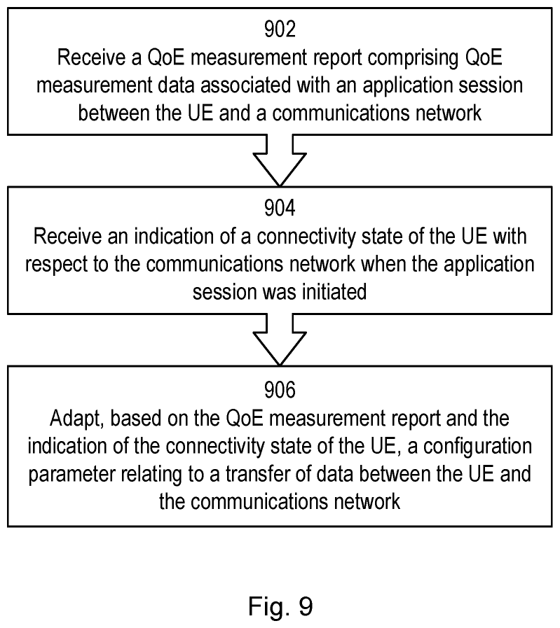

FIG. 9 depicts a method in accordance with particular embodiments. The method of FIG. 9 may be performed by a network node (e.g. the core network node 1008, network node 1010, network node 1200, or network node 1600 as described later with reference to FIGS. 10, FIGS. 12, and 16) of a communications network for receiving UE QoE information. For example, in some embodiments, the network node is a measurement collection entity (MCE) or a RAN node. In some respects, the method shown in FIG. 9 may correspond to the embodiments discussed in sections 2.1-2.3 below. For example, the method of FIG. 9 may correspond to steps performed by a node of the RAN or the MCE discussed in these sections.

The method begins at step 902, with the network node receiving a QoE measurement report comprising QoE measurement data associated with an application session between the UE and the communications network. For example, the QoE measurement data included in the QoE measurement report may comprise RAN visible QoE measurement data. That is, some (or all) of the QoE measurement data may be visible to the RAN, whilst some (or none) of the QoE measurement data may not be visible to the RAN. In another example, the QoE measurement report may be a RAN visible QoE measurement report containing only RAN visible QoE measurement data. In a further example, some or all of the QoE measurement data may not be visible to the RAN (e.g., the QoE measurement report is not RAN-visible). In step 904, the network node receives an indication of a connectivity state of the UE with respect to the communications network when the application session was initiated. In step 906, the network node may adapt, based on the QoE measurement report and the indication of the connectivity state of the UE, a configuration parameter relating to a transfer of data between the UE and the communications network.

For example, the network node may receive QoE and/or RVQoE reports during an ongoing application session (for example, in some embodiments, the QoE measurement data comprises radio access network (RAN) visible QoE measurement data). The network node may then perform adaptive actions to impact the QoE of the concerned application session while the application session is ongoing, such as change various parameters related to the scheduling of the UE and the data flows related to the application session.

In some embodiments, the QoE measurement report is received from any one of: the UE; and a RAN node. In some embodiments, the indication of the connectivity state of the UE is received from any one of: the UE; and a RAN node.

In some embodiments, responsive to the connectivity state of the UE changing from a first connectivity state to a second connectivity state during the application session, the method further comprises receiving an indication of any one or more of: the first connectivity state and the second connectivity state; a time period in which the UE was in the first connectivity state before changing to the second connectivity state; and a timestamp indicating a time at which the connectivity state of the UE changed.

In some embodiments, the connectivity state of the UE comprises one or more of:
a Radio Resource Control (RRC) state;
a Connection Management (CM) state;
a 5G Mobility Management (5GMM) state;
a Mobility Management (MM) state;
a Registration Management (RM) state;
a Registration state;
an Evolved Packet System (EPS) Connection Management (ECM) state; and
an EPS Mobility Management (EMM) state.

In some embodiments, the indication of the connectivity state of the UE is received during the application session. In other embodiments, the indication of the connectivity state of the UE is received after the application session has been terminated.

In some embodiments, the indication of the connectivity state of the UE is received in the same transmission as the QoE measurement report. In other embodiments, the indication of the connectivity state of the UE is received in a different transmission to the QoE measurement report.

Sections 1-3 below discuss embodiments of the disclosure in further detail.

### 1. Terminology and Generalizations

The terms “UE”, “terminal equipment” and “wireless terminal” are used interchangeably.

The terms MCE and TCE are used interchangeably.

The terms “QoE measurement” and “application layer measurement” are used interchangeably.

The terms “application layer measurement configuration”, “application measurement configuration”, “QoE measurement configuration”, “QoE configuration”, “QoE measurement and reporting configuration” and “QMC configuration” are used interchangeably. “QMC configuration file” refers to the part of the QoE configuration consisting of an XML file containing instructions of QoE metrics to be collected etc.

The terms “QoE report” and “QoE measurement report” are used interchangeably. Similarly, the terms “RAN Visible QoE report”, “RAN Visible QoE measurement report”, “RVQoE report” and “RVQoE measurement report” are used interchangeably.

The terms “modem”, “radio layer”, “RRC layer” and “radio network layer” are used interchangeably when referring to a UE.

The terms “access stratum” and “radio layer” are used interchangeably when referring to a UE.

The term “session” is used frequently herein, and it may refer to either a QoE measurement session or an application session or an application session for which QoE measurement is applied.

An application session and a QoE measurement session configured to measure on or collect data from the application session are strongly related. In this document, this is often reflected by referring to a QoE measurement session as being associated with an application session, or by referring to an application session as being associated with a QoE measurement session. When a session of an application of a certain service type is started, and QoE measurements are configured for that service type (i.e. there is a QoE measurement configuration targeting the service type), then a QoE measurement session is also started. The application session and an associated QoE measurement session should thus be started at the same time. Thus, an application session and an associated QoE measurement session are (under normal circumstances) started simultaneously or with a delay between the initiation of the application session and the start of the QoE measurement session that is small enough to be negligible. A possible exception may be if an application session of a certain service type is started and subsequently (while the application session is ongoing) a QoE configuration targeting the service type is received at the UE application layer, and the UE application layer then starts a QoE measurement session to measure on the running application session (instead of the alternative option to not start a QoE measurement session for an already ongoing application session, but instead wait for the next application session of the targeted service type). The same principles apply for RVQoE measurements. In the solution description, unless otherwise stated, an application session and its associated QoE measurement session and/or RVQoE measurement session are assumed to be started simultaneously or with negligible delay between the application session and the QoE measurement session. Mechanisms specifically addressing the case where a QoE measurement session and/or an RVQoE measurement session is started while the associated application session is already ongoing (i.e. the QoE measurement session and/or RVQoE measurement session is started with a non-negligible delay) are elaborated in section 3.3 below.

With the above description of the relation between an application session and an associated QoE measurement session, it is relevant to discuss the meaning of a “session start” indication (which is a term frequently used in the solution descriptions). Whether a session start indication refers to an application session or a QoE measurement session has not been clear in 3GPP during the work with the specification of the QoE framework (in particular QoE for NR). However, the first release 17 version of the NR RRC specification (3GPP TS 38.331 version 17.0.0) implies that a session start indication sent from the UE to the gNB (in the form of an applicationlayer SessionStatus-r17 set parameter to “started” in the MeasurementReportAppLayer message) refers to a started QoE measurement session, and the same should then assumedly apply for the session start indication sent from the UE application layer to the UE AS. Hence, that a session start indication refers to a QoE measurement session is the general assumption in the descriptions of the solutions herein, but the possibility that a session start indication refers to an application session (with an associated QoE configuration) is not excluded and most of the mechanisms in the solutions will still work (partly because a QoE measurement session associated with an application session is assumed to start at the same time as the associated application session (or with a negligible delay)).

In this document, in particular in the description of the solution, the state a UE is in when a certain application session with an associated QoE measurement session is initiated at the UE's application layer is often referred to as the “initial state”.

The solution proposed in this disclosure applies to UMTS, LTE and NR, and potentially other extant communications standards or communications standards to be defined in the future.

All references to the application layer are with respect to the application layer of the UE (since RAN nodes do not have an application layer).

The solution proposed in this disclosure applies to both signaling- and management-based QoE measurements (but may also optionally be restricted to apply to only one of them).

The solution is primarily described in 5G/NR terms, implying application of the solution in 5G/NR, but the solution is also applicable in LTE (in which case for instance a gNB would be replaced by an eNB) or UMTS, and potentially other extant communications standards or communications standards to be defined in the future.

To transition from RRC_INACTIVE state to RRC_CONNECTED state, a UE performs a procedure by which the UE's RRC connection is said to be resumed. This procedure may herein be referred to as a resume procedure, a connection resume procedure, an RRC connection resume procedure or an RRC resume procedure. This procedure consists of a three-way message exchange between the UE and the network (e.g. a gNB), including an RRCResumeRequest or RRCResumeRequest1 message from the UE, followed by an RRCResume message from the network, followed by an RRResumeComplete message from the UE.

To transition from RRC_IDLE state to RRC_CONNECTED state, a UE performs a procedure which establishes an RRC connection for the UE. This procedure may herein be referred to as a connection establishment procedure, an RRC connection establishment procedure, a setup procedure, an RRC setup procedure or an RRC connection setup procedure. In NR, this procedure consists of a three-way message exchange between the UE and the network (i.e., a gNB), including an RRCSetupRequest message from the UE, followed by an RRCSetup message from the network, followed by an RRCSetupComplete message from the UE. In LTE, this procedure consists of a three-way message exchange between the UE and the network (i.e., an eNB), including an RRCConnectionRequest message from the UE, followed by an RRCConnectionSetup message from the network, followed by an RRCConnectionSetupComplete message from the UE.

### 2. General Solutions

The general means to address the problem(s) described above is that the QoE report may be extended with, or complemented with, information about the state (e.g., RRC state) the UE was in when the application session and the QoE measurement session the QoE report pertains to was initiated (for example, via the methods shown in FIGS. 7-9). This UE state is henceforth also referred to as the “initial state”. This solution principle may also be applied to RVQoE measurements and RVQoE measurement reporting.

This additional information may inform the entity analyzing the reported QoE measurement data (e.g., an MCE or an entity to which the MCE forwards the reported QoE measurement data) of which state the UE was in when the concerned application session (i.e., the application session the reported QoE measurement data pertains to, i.e., was collected from) was initiated. This in turn may facilitate for the analyzing entity to properly judge a reported performance metric which may be impacted by the state the UE was in when the application session was initiated. Similarly, a RAN node receiving an RVQoE report may benefit from the state information when analyzing the reported RVQoE metrics and determining any appropriate actions.

### 2.1 UE Application Layer Centric Solution

In some respects, the embodiments discussed in this section may correspond to the method shown in FIG. 7.

When an application session is initiated at the UE application layer, and the application layer starts the associated QoE measurements (in accordance with a QoE configuration associated with the service type to which the application belongs), the application layer obtains information about the state the UE is in.

As one option, the application layer obtains the state information using implementation specific means, e.g., by accessing state variables in a memory storage, and/or through inter-process communication.

As another option, the UE application layer uses an enhanced existing or newly defined AT command to request the state information from the UE AS, or from another entity in the UE which can communicate via AT commands, e.g., an entity responsible for 5GMM states and/or CM states, e.g., an entity responsible for NAS operation. The UE AS, or other UE entity, would respond to the AT command with the requested state information.

As yet another option, the UE application layer can use a “SET” type of AT command to configure the UE AS (and/or other entity in the UE) to send an unsolicited response code every time the UE's state changes (e.g., RRC state transitions), wherein the unsolicited response code conveys information about the UE's state (e.g., its RRC state).

Note: An unsolicited response code is a concept specified and described in 3GPP TS 27.007 version 17.3.0. An unsolicited response code is a means for one entity in the UE (typically lower layers) to inform another entity in the UE (typically higher layers) of an event that has occurred. The entity receiving the unsolicited response code has prior to that enabled such sending of unsolicited response codes by using an AT command to set a configuration parameter in the sending entity, wherein the set configuration parameter indicates that sending of unsolicited response codes is enabled. The framework of enabling, sending and receiving unsolicited response codes can thus be seen as a UE internal mechanism for subscribing to event notifications (where the events are state transitions in this case).

When the UE application layer subsequently transfers a QoE report to the UE AS, the UE application layer includes in the QoE report an indication of the state (e.g., RRC_INACTIVE or RRC_CONNECTED state) the UE was in when the concerned application session and its associated QoE measurement session were initiated. The QoE report in which the state information is included may be a QoE report which, in accordance with the QoE configuration for measurement and reporting, is sent at the end of the application session (and consequently at the end of the QoE measurement session). The QoE report in which the state information is included may also be an intermediate QoE report, i.e., a QoE report which is generated and transferred while the application session and its associated QoE measurement session are still ongoing. A typical case of such an intermediate QoE report is a periodic QoE report (i.e., a QoE report sent in accordance with a configured periodicity). If included in an intermediate QoE report, the RRC state information is preferably included in the first intermediate QoE report (and optionally in all QoE reports). When the UE AS receives a QoE report from the UE application layer, it follows the regular QoE reporting procedure and forwards the QoE report to the RAN (e.g., a gNB or eNB) and the RAN in turn forwards the QoE report to the MCE (or other entity acting as a receiver of QoE reports).

As an alternative to including the state information in the QoE report, the UE application layer may send the state information as one or more separate parameter(s) outside (but together with) the QoE report (which is a “container” or bit string the UE AS cannot read, or at least cannot understand), or send the QoE report and the state information in separate AT commands closely following each other. If the state information is sent to the UE AS in the form of one or more separate parameters (not included in the QoE report), the UE AS sends the state information together with the QoE report to the RAN (as opposed to only sending the QoE report when the state information is included in the QoE report). The RAN (e.g., the gNB or eNB) in turn forwards the state information to the MCE, either as a part of the QoE report (if the UE application layer included the state information in the QoE report), or together with the QoE report as one or more separate parameter(s), if that is the way the state information was reported from the UE.

The state information may consist of a state indication, e.g., indicating RRC_INACTIVE state or RRC_CONNECTED state. As an option, there may be multiple state indications, e.g., one indicating the RRC state (e.g., indicating one of the two states RRC_INACTIVE or RRC_CONNECTED state, or indicating one of the three states RRC_IDLE, RRC_INACTIVE or RRC_CONNECTED state), one indicating the 5GMM state and one indicating the CM state. In general, there may be an indication for each of the following states (wherein all or a subset may be indicated):
Radio Resource Control (RRC) state
   RRC_IDLE
   RRC_INACTIVE
   RRC_CONNECTED
   RRC non-connected state (any non-connected state)
Connection Management (CM) state
   CM-IDLE
   CM-CONNECTED
5G Mobility Management (5GMM) state
   5GMM-REGISTERED
   5GMM-DEREGISTERED
   5GMM-REGISTERED-INITIATED
   5GMM-DEREGISTERED-INITATED
   5GMM-SERVICE-REQUEST-INITIATED
   5GMM-NULL
Mobility Management (MM) state
Registration Management (RM) state
   RM-REGISTERED
   RM-DEREGISTERED
Registration state
   REGISTERED
   DEREGISTERED
EPS Connection Management (ECM) state
   ECM-IDLE
   ECM-CONNECTED
   EPS Mobility Management (EMM) state
   EMM-REGISTERED
   EMM-DEREGISTERED
   EMM-REGISTERED-INITIATED
   EMM-DEREGISTERED-INITATED
   EMM-SERVICE-REQUEST-INITIATED
   EMM-TRACKING-AREA-UPDATING-INITIATED
   EMM-NULL
Any other UE state

If the UE did not remain in the initial state (i.e., the state the UE was in when the application session and QoE measurement session was initiated) for the entire application session and/or the entire QoE measurement session, the state information may indicate how long time the UE was in the initial state, before transiting to another state, or a timestamp indicating the instant when the transition occurred (the timestamp added based on, e.g., an indication from the UE AS layer that the state transition occurred). For instance, if the UE was in RRC_INACTIVE state when the application session and its associated QoE measurement session were initiated, in addition to the indication of the initial state (i.e. RRC_INACTIVE state), the state information may contain an indication of how long the UE remained in RRC_INACTIVE state before it transited to RRC_CONNECTED state (or before it had completed the transition to RRC_CONNECTED state), e.g. the time from the application session and/or QoE measurement session initiation until the UE had transited to RRC_CONNECTED state or the time from the application session and/or QoE measurement session initiation until the first user plane packet was sent over the radio interface. Such state information may optionally include multiple state transitions, e.g. transition between different substates, e.g. in the process of transition between two main states, and wherein the time spent in each state or substate, or the timestamps pertaining to transition events, may be indicated.

If the UE was in RRC_INACTIVE state or in RRC_IDLE state when the application session and its associated QoE measurement session were initiated, the state or state transition related information to report may further include an indication of whether the trigger for the UE to transition from RRC_INACTIVE or RRC_IDLE state to RRC_CONNECTED state originated in the UE or came from the network (where the former typically may be the start of an application session and/or arrival/creation of uplink data to transmit, and the latter may typically be a page from the network, e.g. RAN paging in case of RRC_INACTIVE state or CN paging in case of RRC_IDLE state (see section 3.6 for further details about state transition triggered by paging)).

Depending on the nature of the state information, different parts of the state information, or different types of state information, may be included in different QoE reports. In general, any QoE report may include state information.

In addition to a QoE measurement configuration, a RAN Visible QoE (RVQoE) measurement configuration may be provided to the UE, and in the case of RVQOE, the configuration is created by the RAN, e.g., a gNB or an eNB. In release 17 of the 3GPP standard, there is no support for configuring an RVQoE measurements independently of regular QoE measurement configurations, i.e., it is not possible to configure RVQoE measurements without a corresponding QoE measurement configuration. However, provision of RVQoE measurement configurations independently of QoE measurement configurations (e.g., providing an RVQoE measurement configuration for a certain service type without providing a QoE measurement configuration for the same service type) may be enabled in future 3GPP releases.

Just as described for QoE reports, the above-described state information may be included in an RVQoE report too (or be sent together with the RVQoE report). The state information may be included in (or may be associated with) an RVQoE report and included in (or associated with) a QoE report containing measurement data collected from the same application session. It is also possible that, even if both QoE measurements and RVQoE measurements are configured for an application session (i.e. for the application's service type), only one of the report types may convey any state information. For instance, state information may be included in in (or associated with) one or more QoE report(s), but not in (or associated with) any RVQoE report. As another example, state information may be included in (or associated with) one or more RVQoE report(s), but not in (or associated with) any QoE report. If state information is included in (or associated with) both one or more QoE report(s) and one or more RVQoE report(s), the type of state information may differ between the one or more QoE report(s) and the one or more RVQoE report(s). For instance, the one or more QoE report(s) may indicate (as included or associated information) the initial state as well as the time the UE spent in the initial state, whereas the one or more RVQoE report(s) (containing measurement data collected during the same application session) may only indicate (as included or associated information) the initial state.

Whether the UE application layer should report state information—in particular about the initial state—in QoE report(s) may be configured in the QMC configuration file (i.e., the Extensible Markup Language (XML) file comprising indications of the metrics to be collected, etc.) or it may be configured via a QoE configuration parameter separate from the QMC configuration file. If a separate parameter is used (which may be conveyed from the O&M system to the RAN in case of management-based QoE configuration or via the CN for signaling-based QoE configuration), the RAN, e.g., the gNB or eNB, should forward the configuration parameter (possibly reformatted) to the UE AS, which in turn should forward the instruction to the UE application layer. An instruction to include state information in a QoE report may comprise instructions of which type(s) of state information the UE application layer should report.

Whether the UE application layer should report state information—in particular about the initial state—in RVQoE report(s) may be configured as a part of the RVQoE configuration. The RAN, e.g., the gNB or eNB, creates this configuration and sends it to the UE AS, which forwards it to the UE application layer.

The network (e.g., the RAN, the O&M system etc.) may learn from a newly defined or an enhanced existing UE capability signaling whether the UE is capable of providing the state information by means of a UE application layer centric solution (as in section 2.1 and/or by means of a UE AS layer-centric solution (section 2.2).

An alternative to configuring whether state information should be reported in QoE report(s) and/or RVQoE report(s) would be to mandate the behavior through specification in a standard.

### 2.2 UE AS Centric Solution

In some respects, the embodiments discussed in this section may correspond to the method shown in FIG. 7.

With this solution, the UE AS rather than the UE application layer is responsible for noting and reporting the state information, e.g., the state the UE was in when the application session and its associated QoE (and/or RVQoE) measurement session were initiated (i.e., the initial state).

To enable reporting of relevant state information, the UE AS uses reception of a session start indication (indicating that a QoE measurement session with an associated application session has started) from the UE application layer as a trigger to record state information, in particular the state the UE is in when the UE AS receives the session start indication (i.e., the initial state). Reception of a subsequent session stop indication pertaining to the same QoE measurement session (indicating that the QoE measurement session has ended) may trigger the UE AS to stop recoding state information. A possible alternative, or complement, to using a session start indication as a trigger for recording of state information, the UE AS may use reception of a Recording Session ID from the UE application layer. As an additional alternative, the UE AS can implicitly be triggered to record state information upon the reception of the first chunk of UL or DL data for the application session. As yet another alternative, the UE may record state changes (and state related and/or state transition related information) continuously, e.g. during a certain period, e.g. during an ongoing QoE measurement session (e.g. marked by reception by the UE AS of a session start indication and a subsequent session stop indication) or while application layer measurements are configured, and optionally report the recorded information to the network, as described further below.

Optionally, e.g., if the UE AS is configured to do so, the UE AS also measures and records (for later reporting) the time the UE spends in the initial state before it transits to another state (if it does such a state transition while the application session and the QoE measurement session are ongoing), as well as optionally (e.g., if the UE AS has been configured to do so) measures and records any of the types of state information described above in section 2.1. Alternatively, the UE AS may record state changes together with time stamps indicating the times that the UE changed state. The records are likely to be made during a certain period, e.g., when there is a QoE measurement session ongoing in the UE (e.g. marked by reception by the UE AS of a session start indication and a subsequent session stop indication) or during the time when the UE is configured with application layer measurements.

When the UE AS subsequently receives a QoE report from the UE application layer, the UE AS sends the recorded state information to the RAN (e.g., the gNB or eNB) together with the QoE report. The RAN in turn forwards the QoE report and the state information to the MCE (or other receiver of the QoE report).

The same method for recording state information can be used when the UE AS is to report state information in conjunction with RVQoE reports. When the UE AS receives an RVQoE report from the UE application layer, it either includes the state information in the set of an RVQoE metrics parameters constituting the RVQoE report it sends to the RAN (e.g., the gNB or eNB), or sends the state information to the RAN together with the RVQoE metrics parameters (i.e., together with the QoE report). Alternatively, the state information is defined as one or more RVQoE metric(s) or one or more RVQoE value(s), and if the UE is configured to send information, likely during a certain period, it reports it to the RAN as an RVQoE report.

The state information that may be reported in conjunction with reporting of QoE metrics, and/or in conjunction with reporting of RVQoE metrics or RVQoE values, may be the same as described above for the UE application layer centric solution in section 2.1.

The UE AS cannot read the QMC configuration file (i.e., the XML file containing instructions on which QoE metrics to collect etc.). At least the UE AS cannot be expected or assumed to be capable of interpreting and understanding the content of the QMC configuration file. Hence, including a configuration of whether the UE should report state information in the QMC configuration file is less favorable in the UE AS centric solution than in the UE application centric solution described in section 2.1. However, this means for configuration is still a feasible alternative. If this configuration means is used, the UE application layer, which is the receiver and reader of the QMC configuration file, should inform the UE AS of the configuration. At least the UE application layer should inform the UE AS if the configuration says that state information should be reported (and which type of state information if applicable), whereas if the configuration does not say that state information should be reported, as one option, the UE application layer may not inform the UE AS and this lack of information would then be an implicit indication to the UE AS that state information should not be reported. The UE application layer could inform the UE AS of whether state information should be reported in the one of the following ways:
In the AT command (or other type of message/information transfer) conveying the QoE report to the UE AS, e.g. the +CAPPLEVMRNR or +CAPPLEVMR command.
In the AT command (or other type of message/information transfer) conveying the session start indication (e.g. indicating the start of a QoE measurement session) to the UE AS, e.g. the +CAPPLEVMRNR or +CAPPLEVMR command or a new AT command or unsolicited response code.
In a response or acknowledgement to the message (e.g., AT command or unsolicited response code) from the UE AS conveying the QoE configuration (including the QMC configuration file) to the UE application layer.
Together with application layer data.

For the embodiment where the UE application layer informs the UE AS when it sends a QoE report to the UE AS, the UE AS, at the time of receiving the session start indication from the UE application layer, may not know whether it later should report information about the state the UE is in at this time. Consequently, the UE AS may have to record this information (e.g. record the UE's RRC state) when it receives the session start indication, without knowing whether this information may later be used or not. That the UE application layer informs the UE AS in the UE internal message (e.g., AT command, e.g., the +CAPPLEVMRNR or +CAPPLEVMR command, or a new AT command, or unsolicited response code) conveying the session start indication may be the preferred alternative.

A more preferable method for configuration of the UE AS may be to use a QoE configuration parameter separate from the QMC configuration file. Such a separate parameter may be conveyed from the O&M system to the RAN for management-based QoE configuration, or from the O&M system via the CN for signaling-based QoE configuration, together with the other QoE configuration parameters (including the QMC configuration file). The RAN, e.g., the gNB or eNB, may in turn forward the configuration parameter (possibly reformatted) to the UE AS.

Whether the UE AS layer should report state information—in particular about the initial state—in RVQoE report(s) may be configured as a part of the RVQoE configuration. The RAN, e.g., the gNB or eNB, creates this configuration and sends it to the UE AS.

A configuration in the form of an instruction to report state information together with a QoE report may comprise instructions of which type(s) of state information the UE application layer should report. As previously described, this state information could be included in the QoE report, based on explicit or implicit indications from the UE AS layer, or an application's inherent knowledge of the state, or it could be sent together with a QoE report.

An alternative to configuring whether state information should be reported in QoE report(s) and/or RVQoE report(s) may be to mandate the behavior through specification in a standard.

### 2.3 Network (RAN Node) Centric Solution

In some respects, the embodiments discussed in this section may correspond to the method shown in FIG. 8.

With this solution, the RAN, e.g., the gNB or the eNB, is responsible for determining the state information (in particular, the initial state) and for conveying it to the MCE together with the QoE report. To do this, the RAN relies on session start indications received from the UE in combination with the RAN's inherent knowledge of the UE's state. If the gNB receives the session start indication in a MeasurementReportAppLayer message right after the UE has resumed from RRC_INACTIVE state to RRC_CONNECTED state, or in conjunction with the RRC resume procedure (possibly including a failed/rejected RRC resume procedure resulting in a fallback to RRC connection establishment), the gNB could assume that the UE was in RRC_INACTIVE state when the application session was initiated, and that it was this application session initiation that triggered the UE's request to resume the RRC connection. If the session start indication is conveyed in conjunction with the RRC resume procedure, the session start indication may be included in the RROResumeComplete message or even in the RR (′ResumeRequest RRCResumeRequest1 message (e.g. utilizing the spare bit currently included in the RRCResumeRequest RRCResumeRequest1 message in the 17.0.0 version of the RRC specification 3GPP TS 38.331), or, in case of a failed/rejected RRC resume procedure resulting in a fallback to RRC connection establishment, as part of the RRCSetupComplete message (or RR (ConnectionSetupComplete in LTE) or possibly the RRCSetupRequest message (or RR (ConnectionRequest message in LTE).

If retaining and application of a QoE configuration is enabled for a UE in RRC_IDLE state (which is not possible with the 3GPP release 17 specifications), the RAN may use the same principles as described above, but instead of an RRC connection resume procedure, the UE may perform an RRC connection establishment procedure.

The kind of state information the RAN reports together with the QoE report could be the same as described in previous chapters.

The state information could be forwarded from the RAN to the MCE continuously when the UE changes state, likely during a certain period, e.g., when there is a session (i.e. a QoE measurement session associated with an application session) ongoing in the UE (between a session start and a session stop indication), or when the UE is configured with application layer measurements. Alternatively, the state information could be collected and logged by the RAN, e.g., in a file, together with time stamps, indicating the times that the UE changed state. The file could be forwarded from the RAN to the MCE, e.g., on its own or together with QoE or RVQoE reports.

For this network (RAN node) centric solution, there may be some uncertainty in the assumption that the RRC resume (or RRC setup) procedure was triggered by the initiation of the application session whose associated QoE measurement session the session start indication pertains to. For example, in some corner cases, the trigger of the RRC resume procedure may have been something else and then the application session happened to be initiated closely after that trigger, either before or after the completion of the RRC resume (or RRC setup) procedure. Hence, it may not be certain that the reported initial playout delay will include the entire RRC connection resume delay (or RRC connection setup delay) (i.e., the time to transition from RRC_INACTIVE (or RRC_IDLE) state to RRC_CONNECTED state).

This uncertainty could be eliminated if the UE explicitly indicates that the trigger of the RRC resume procedure was the initiation of an application session with a certain associated QoE measurement session. The ResumeCause IE could be extended, or redefined, for this purpose. There are currently five spare ENUMERATED values for the ResumeCause IE in 3GPP TS 38.331 version 17.0.0, which could be used for this purpose. Furthermore, the MeasConfigAppLayerId could be included in the RRCResumeRequest/RRCResume Request1 message or the RRCResumeComplete message to indicate the activated QoE configuration as well as the type of application session that has started.

This RAN behavior could be standardized, but perhaps more preferable would be to make it configurable, or dynamically indicated as a part of (or together with) the QoE measurement configuration the RAN receives from the O&M system or from the CN (which forwards the QoE measurement configuration from the O&M system in case of a signaling based QoE measurement configuration). It would also be possible to include the indication in the QMC configuration file and let the UE application layer forward the indication to the UE

AS together with the QoE report or RAN visible QoE report, and let the UE AS further forward the indication to the RAN together with the QoE report or RAN visible QoE report.

### 3. Extensions

### 3.1 The UE AS Measures and Reports the Delay Incurred by the RRC Resume (or RRC Setup) Procedure

In some respects, the embodiments discussed in this section may be extensions of the method shown in FIG. 7.

When the UE AS is responsible for determining and reporting the state information, and the UE AS is configured (or mandated by standard) to do so for a certain QoE configuration, the UE AS may record the delay the RRC resume procedure incurred and report this together with, or as a part of, the state information sent to the RAN together with the QoE report. This may thus form a part of the total delay from the initiation of the application session and its associated QoE measurement session until the UE has entered RRC_CONNECTED state, and providing this information enables the entity analyzing the reported information (e.g. the MCE) to perform a more detailed analysis of what happened in the very initial stage of the application session with the associated QoE measurement session.

To this end, when the UE is in RRC_INACTIVE state, the UE AS may record the time when it receives the session start indication from the UE application layer and compare that with the subsequent time of completion of the triggered RRC resume procedure to calculate the delay incurred by the RRC resume procedure.

If the UE application layer, when it sends a QE report to the UE AS, informs the UE AS that it should report the state information (in particular the initial state) together with the QoE report, the UE AS may not have been aware of this when the session start indication was previously received. Hence, in this case, when the UE is in RRC_INACTIVE state, the UE AS may have to proactively record the time when it receives a session start indication from the UE application layer, and calculate the delay incurred by the triggered RRC resume procedure, without knowing whether this information may be needed.

In this context, the start of the RRC resume procedure may be defined as the transmission of the random access preamble whose subsequently associated Msg3 (or MsgA Physical Uplink Shared Channel (PUSCH) transmission) includes the RR (ResumeRequest RRCResumeRequest1 message, or, alternatively, as the transmission of the RRCResumeRequest/RRCResumeRequest1 message. The completion of the RRC resume procedure may be defined as the transmission of the RR (ResumeComplete message, or in case of failed RRC resume procedure resulting in fallback to RRC connection establishment, the transmission of the RRCSetupComplete message.

The herein described measurement and reporting of the delay incurred by the RRC resume procedure can be generalized to measurement and reporting of another state transition delay too, in particular a state transition from RRC_IDLE state to RRC_CONNECTED state. If retaining and application of a QoE configuration is enabled for a UE in RRC_IDLE state (which is not possible with the 3GPP release 17 specifications), the above-described procedure may thus be adapted to be performed on the RRC setup procedure in a similar way as described above for the RRC resume procedure. To this end, the start of the RRC setup procedure may be defined as the transmission of the random access preamble whose subsequently associated Msg3 (or MsgA PUSCH transmission) includes the RRCSetupRequest message (in NR) or RRCConnectionRequest message (in LTE), or, alternatively, as the transmission of the RRCSetupRequest message (in NR) or RRCConnectionRequest message (in LTE). The completion of the RRC setup procedure may be defined as the transmission of the RRCSetupComplete message (in NR) or the RRCConnectionSetupComplete message (in LTE).

### 3.2 the RAN Measures and Reports the Delay Incurred by the RRC Resume (or RRC Setup) Procedure

In some respects, the embodiments discussed in this section may be extensions of the method shown in FIG. 8.

When the RAN (e.g. the gNB or the eNB) is responsible for determining and reporting the state information, and the RAN is configured (or mandated by standard) to do so for a certain QoE configuration, the RAN may record the delay the RRC resume procedure incurred and report this together with, or as a part of, the state information sent to the MCE together with the QoE report. This may thus form a part of the total delay from the initiation of the application session and its associated QoE measurement session until the UE has entered RRC_CONNECTED state, and providing this information enables the entity analyzing the reported information (e.g. the MCE) to perform a detailed analysis of what happened in the very initial stage of the application session with the associated QoE measurement session.

The RAN node (e.g. gNB or eNB) may inherently record such information, but otherwise the RAN node may record the time when the RRC resume procedure is initiated for a UE which is configured with a QoE configuration for which the RAN node is configured (or mandated by standard) to report the delay incurred by the RRC resume procedure. At the time of completion of the RRC resume procedure, the RAN node may compare the time with the recorded time to calculate the delay incurred by the RRC resume procedure and report this delay together with, or as a part of, the state information sent together with a subsequent QoE report to the MCE.

This selective approach would work whilst the UE resumes in the same cell- or at least in a cell belonging to the same RAN node—as the cell in which it was released to RRC_INACTIVE state. However, if the UE resumes in another cell, e.g., a cell belonging to another RAN node than the anchor RAN node (e.g., the anchor gNB), then the new RAN node may not know about its duties until it has fetched the UE's context from the anchor RAN node. Hence, if also this case is to be covered, the RAN node may have to record the time of the RRC resume procedure without knowing whether the UE does have a QoE configuration for which this is configured (or mandated by standard), and after having fetched the UE's context, the new RAN node may choose whether to discard the recorded time (because it turned out it was not needed) or keep it to be compared with the time of completion of the RRC resume procedure.

In this context, the start of the RRC resume procedure may be defined as the reception of the RRCResumeRequest RRCResumeRequest1 message or, alternatively, the reception of the random access preamble whose subsequently associated Msg3 (or MsgA PUSCH transmission) includes the RRCResumeRequest RRCResumeRequest1 message. The completion of the RRC resume procedure may be defined as the reception of the RROResumeComplete message or, in case of failed RRC resume procedure resulting in a fallback to RRC connection establishment, the reception of the RRCSetupComplete message (or RR (ConnectionSetupComplete message in LTE).

The herein described measurement and reporting of the delay incurred by the RRC resume procedure can be generalized to measurement and reporting of another state transition delay too, in particular a state transition from RRC_IDLE state to RRC_CONNECTED state. If retaining and application of a QoE configuration is enabled for a UE in RRC_IDLE state (which is not possible with the 3GPP release 17 specifications), the above-described procedure may thus be adapted to be performed on the RRC setup procedure in a similar way as described above for the RRC resume procedure. For the RRC setup procedure, the situation is similar to the case where the UE resumes the RRC connection in another RAN node than the anchor RAN node. That is, the RAN node may have to record the time and/or delay of the RRC setup procedure without knowing whether the UE does have a QoE configuration for which this is configured (or mandated by standard). In this context, the start of the RRC setup procedure may be defined as the reception of the RRCSetupRequest message in NR or RRCConnectionRequest message in LTE, or, alternatively, the reception of the random access preamble whose subsequently associated Msg3 (or MsgA PUSCH transmission) includes the RRCSetupRequest or RRCConnectionRequest message. The completion of the RRC setup procedure may be defined as the reception of the RRCSetupComplete message in NR or the RRCConnectionSetupComplete message in LTE.

### 3.3 Reporting Additional Information Related to the State, State Transition and State Transition Procedure

In some respects, the embodiments discussed in this section may be extensions of the methods shown in FIGS. 7 and 8.

The reported state information, possibly including the state transition procedure related information described in section 3.1 and/or the state transition procedure related information described in 3.2, may be complemented with further information related to the state, state transition and/or the state transition procedure.

This may for instance be information related to the outcome of the procedure, such as one or more of the following:
Successful state transition procedure.
   This could specifically indicate a successful RRC resume procedure.
   This could specifically indicate a successful RRC setup procedure
Successful state transition procedures after N preceding failed state transition procedures.
   This could specifically indicate RRC resume procedures.
   This could specifically indicate RRC setup procedures.
Number of state transition failures triggered by traffic generated by the concerned application session.
   This may be specifically indicated for state transitions from RRC_INACTIVE to RRC_CONNECTED state.
   This may be specifically indicated for state transitions from RRC_IDLE to RRC_CONNECTED state.
Successful transition to RRC_CONNECTED state followed by connection failure, e.g. radio link failure, within a duration D after the state transition.
   This may be indicated specifically for a state transition from RRC_INACTIVE to RRC_CONNECTED state.
   This may be indicated specifically for a state transition from RRC_IDLE state.
Fallback of the RRC resume procedure to the RRC setup procedure (e.g. triggered by receiving, in the UE, an RRCSetup message in response to an RR (ResumeRequest message or an RR (ResumeRequest1 message).
The duration of the state transition procedure exceeded a threshold duration D.
   This may be indicated specifically for a state transition from RRC_INACTIVE to RRC_CONNECTED state.
   This may be indicated specifically for a state transition from RRC_IDLE state.
The duration of the state transition procedure was shorter than a threshold duration D.
   This may be indicated specifically for a state transition from RRC_INACTIVE to RRC_CONNECTED state.
   This may be indicated specifically for a state transition from RRC_IDLE state.
The number of random access attempts required to achieve a successful state transition.
   This may be indicated specifically for a state transition from RRC_INACTIVE to RRC_CONNECTED state.
   This may be indicated specifically for a state transition from RRC_IDLE state.
The number of random access attempts required to achieve a successful state transition exceeded a threshold number N.
   This may be indicated specifically for a state transition from RRC_INACTIVE to RRC_CONNECTED state.
   This may be indicated specifically for a state transition from RRC_IDLE state

To support some of the above, in some embodiments, the UE AS logs any failure of the state transition procedure. In a non-limiting example, if the RRC resume procedure fails, the UE records that the RRC resume procedure failed when the RRC resume procedure was triggered by a started application session with an associated QoE measurement session. In other embodiments, the UE AS logs information indicating that an RRC resume procedure (which was triggered by the start of an application session with an associated QoE measurement session) fell back to the RRC setup procedure, as requested/instructed by the network. The UE logs such information and reports it to the network, e.g., inside or together with the QoE report(s) and/or RVQoE report(s) (either the QoE measurements received from the upper layers or the RAN visible QoE measurements). The logged information related to the state transition(s) may also be reported separately from and independently of the QoE report(s) and RVQoE report(s). The information may also contain details about the duration of the state transition procedure including the extra time taken due to the failure.

Other information that implicitly provides information about the nature of, or circumstances for the state, state transition or state transition procedure may include information related to the radio access technology or the type of cell the UE is (or was) located in, such as one or more of the following:
Radio access technology
   NR
   LTE
   UMTS
   NR operating in shared (unlicensed) spectrum
   LTE operating in shared (unlicensed) spectrum (e.g. LTE Licensed-Assisted Access, LTE LAA)
   NR operating in a Non-Terrestrial Network
   LTE operating in a Non-Terrestrial Network
   WiFi
   Wireless Local Area Network (WLAN)
Cell type
   NR cell
   Macro cell
      Macro NR cell
      Macro LTE cell
      Macro UMTS cell
   MIcro cell
      MIcro NR cell
      MIcro LTE cell
      MIcro UMTS cell
   Femto cell
      Femto NR cell
      Femto LTE cell
      Femto UMTS cell
   Closed Subscriber Group (CSG) cell
      NR CSG cell
      LTE CSG cell
      UMTS CSG cell
   Integrated Access and Backhaul (IAB) cell
   Relay cell
   Mobile IAB cell
   Vehicle Mounted Relay (VMR) cell
   High-Speed Train (HST) cell
   WiFi cell
Cell identity
   NR Cell Global Identifier (NCGI)
   E-UTRAN Cell Global Identifier (ECGI)
   CGI
   NCGI+Physical Cell ID (PCI)
   ECGI+PCI
      3.4 Special Considerations for the Cases when the QoE Measurements Start after the Application Session

In some respects, the embodiments discussed in this section may be extensions of the method shown in FIGS. 7 and 8.

If the QoE measurement session starts when the application session has already been started (e.g. if the QoE measurement configuration was received at the UE application layer when an application session of the service type targeted by the QoE measurement configuration had already started and was ongoing), the entity responsible for collecting and reporting the state information (e.g., the UE application layer, the UE AS or the RAN node) may, as one option, choose to (or may be configured to, or may be mandated by standard to) not report any state information, since the impact of the initial state on the application session may not be captured in the collected QoE metrics (with some exceptions which are mentioned further below).

As another option, the entity responsible for collecting and reporting the state information (e.g. the UE application layer, the UE AS or the RAN node) may choose to (or may be configured to or may be mandated by standard specification to) not report any state information if the QoE measurement session starts after the application session and, when the QoE measurement starts, the UE has transited to another state than it was in when the application session started. (There are various ways the information of whether the UE was in another state when the application session started than the state it was in when the associated QoE measurement started may be obtained. One possibility is that this option is only used if the required information is logged, or at least recorded and temporarily stored. Another view is that it can be assumed that when this option is to be used, the impacted entity is implemented in a way that the required information is logged, or at least recorded and temporarily stored.)

As yet another option, in these cases, the entity responsible for collecting and reporting the state information (e.g. the UE application layer, the UE AS or the RAN node) may report any state information to the extent possible, but may indicate together with the state information, that the QoE measurement session started with a non-negligible delay after the application session, wherein this complementing information about the start of the QoE measurement session further may include an indication of whether the UE was in another state when the QoE measurement session started than the UE was in when the associated application session started. These two indications, i.e. the indication that the QoE measurement session started with a non-negligible delay after the application session and the indication of whether the UE was in another state when the QoE measurement session started than the UE was in when the associated application session started may be comprised in the same parameter.

For some service type (e.g., MBS) the QoE measurement session may start when the service which the application session (at UE level) is associated with, has already been activated, and the UE initial state at the time when transmission of data occur is RRC_INACTIVE or RRC_IDLE. A similar scenario can happen when a UE joins an already established MBS multicast session or an already established MBS broadcast session, and no data has yet been sent to the UE after the QoE measurement configuration has been received at the UE application layer, resulting in the UE being in RRC_INACTIVE state or in RRC_IDLE state when transmission of data to the UE is finally initiated. In such cases, the entity responsible for collecting and reporting the state information (e.g., the UE application layer, the UE AS or the RAN node) may choose to (or may be configured to, or may be mandated by standard to) report state information, since the impact of the initial state on the application session in these cases may be captured in the collected QoE metrics.

For the QoE or RAN visible QoE measurements that are event-triggered, and where consequently the measurement start does not necessarily coincide with the start of the application session, the indication of RRC state pertains to the instant when the measurements have started, rather than to the instant when the application session has started. In this case, the entity responsible for collecting and reporting the state information (e.g., the UE application layer, the UE AS or the RAN node) may choose to (or may be configured to or may be mandated by standard to) report state information, since the impact of the initial state on the application session in this case may be captured in the collected QoE metrics.

3.5 Omitting the State Information if the UE was in RRC_CONNECTED State when the Session was Initiated

In some respects, the embodiments discussed in this section may be extensions of the method shown in FIGS. 7 and 8.

As a possible option, the entity responsible for collecting and reporting state information (e.g. the UE application layer, the UE AS or the RAN node) may omit the state information (i.e. refrain from reporting it) when sending/forwarding the QoE report, if the UE was in RRC_CONNECTED state when the application session was initiated.

If the state information consists of more than an indication of the initial state, a variation of this option may be that the entity responsible for collecting and reporting state information (e.g. the UE application layer, the UE AS or the RAN node) may omit parts of the state information (i.e. refrain from reporting it) when sending/forwarding the QoE report or RVQoE report, if the UE was in RRC_CONNECTED state when the application session was initiated.

The behavior of the entity responsible for collecting and reporting state information (e.g. the UE application layer, the UE AS or the RAN node) to omit all or parts of the state information when sending/forwarding the QoE report if the UE was in RRC_CONNECTED state when the application session was initiated may be controlled through configuration or may be mandated by standard. For example, the QoE measurement configuration or the RAN visible QoE measurement configuration, may contain an indication of whether the state information should be reported, should not be reported, or parts of it should be reported, despite that the application session was initiated in RRC_CONNECTED state.

If the relevant configuration or standard specification states that state information should be reported when the UE was in another state than RRC_CONNECTED state when the application session with an associated QoE measurement session started, then the entity receiving the QoE report, e.g. an MCE, may interpret lack of state information conveyed together with, or inside, the first received QoE report (and/or RVQoE report) for a certain application session as an implicit indication that the UE was in RRC_CONNECTED state when the application session the QoE report (and/or RVQoE report) pertains to started.

As variation of the main feature of this section, the entity responsible for collecting and reporting state information (e.g., the UE application layer, the UE AS or the RAN node) may omit the state information (i.e. refrain from reporting it) when sending/forwarding the QoE report (and/or RVQoE report), if the UE was in RRC_IDLE state when the application session was initiated.

As another variation of the main feature of this section, the entity responsible for collecting and reporting state information (e.g., the UE application layer, the UE AS or the RAN node) may omit the state information (i.e., refrain from reporting it) when sending/forwarding the QoE report (and/or RVQoE report), if the UE was in either RRC_CONNECTED state or RRC_IDLE state when the application session was initiated.

In all the above options in this section (i.e. section 3.5), the condition that the application session was initiated in RRC_CONNECTED state may be replaced by a condition that the QoE measurement session (and/or RVQoE measurement session) was initiated in RRC_CONNECTED state.

### 3.6 State Transition Triggered by Paging

In some respects, the embodiments discussed in this section may be extensions of the method shown in FIGS. 7 and 8.

In the embodiments described above, the state transition is triggered by initiation of an application session in a UE, presumably because the application generates data to be sent (e.g. a request or a login message to an application server or maybe a call to a Domain Name System (DNS) server).

However, paging may also trigger a UE to initiate a state transition procedure, and the page in turn may be triggered by downlink application data pending to be transmitted to the UE. In the case of a UE in RRC_INACTIVE state, the UE may be paged through RAN paging and reception of the page may trigger the UE to initiate the RRC resume procedure to transit to RRC_CONNECTED state. In the case of a UE in RRC_IDLE state (which will be relevant in the context of this disclosure, if future 3GPP releases enable a UE to retain a QoE configuration in RRC_IDLE state), the UE may be paged through CN paging and reception of the page may trigger the UE to initiate the RRC setup procedure to transit to RRC_CONNECTED state.

In cases where a page triggers the UE to transit to RRC_CONNECTED state to receive data pertaining to an application session for which there is an associated QoE measurement session and/or RVQoE measurement session, the UE may include in the reported state and/or state transition related information an indication of each page that occurred, the type of page (or equivalently which state the UE was in when it was paged), and/or the delay from the reception of the page until the state transition was concluded and/or the delay from the reception of the page until reception of the first downlink application data in the user place after the transition to RRC_CONNECTED state.

3.7 Adapting the Solution to a Case where the Session is Initiated in RRC_IDLE State

In some respects, the embodiments discussed in this section may be extensions of the method shown in FIGS. 7 and 8.

In 3GPP release 17, retaining of a QoE configuration in RRC_IDLE state is not supported, but this may be changed in future releases of the 3GPP standard. In anticipation of this potential augmentation of the 3GPP standard, all the methods, embodiments, options and variants described above involving RRC_INACTIVE state may be adapted to be applied in relation to the RRC_IDLE state instead of the RRC_INACTIVE state (for instance that the application session and/or associated QoE measurement session (and/or RVQoE measurement session) is initiated when the UE is in RRC_IDLE state). This adaptation involves replacing the RRC resume procedure with the RRC setup procedure, while keeping all the other principles and features of the methods, embodiments, options and variants. Note that this adaptation to the RRC_IDLE state is to some extent explicitly described for some of the methods, embodiments, options and variants described above.

FIG. 10 shows an example of a communication system 1000 in accordance with some embodiments.

In the example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3^{rd} Generation Partnership Project (3GPP) access node or non-3GPP access point. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), Policy Control Function (PCF) and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 10, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, a content source and analytics node, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

FIG. 11 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs). The processing circuitry 1102 may be operable to provide, either alone or in conjunction with other UE 1100 components, such as the memory 1110, UE 1100 functionality. For example, the processing circuitry 1102 may be configured to cause the UE 1102 to perform the methods as described with reference to FIG. 7.

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In some embodiments, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node 1200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes processing circuitry 1202, a memory 1204, a communication interface 1206, and a power source 1208, and/or any other component, or any combination thereof. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, network node 1200 functionality. For example, the processing circuitry 1202 may be configured to cause the network node to perform the methods as described with reference to FIG. 8 or FIG. 9.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

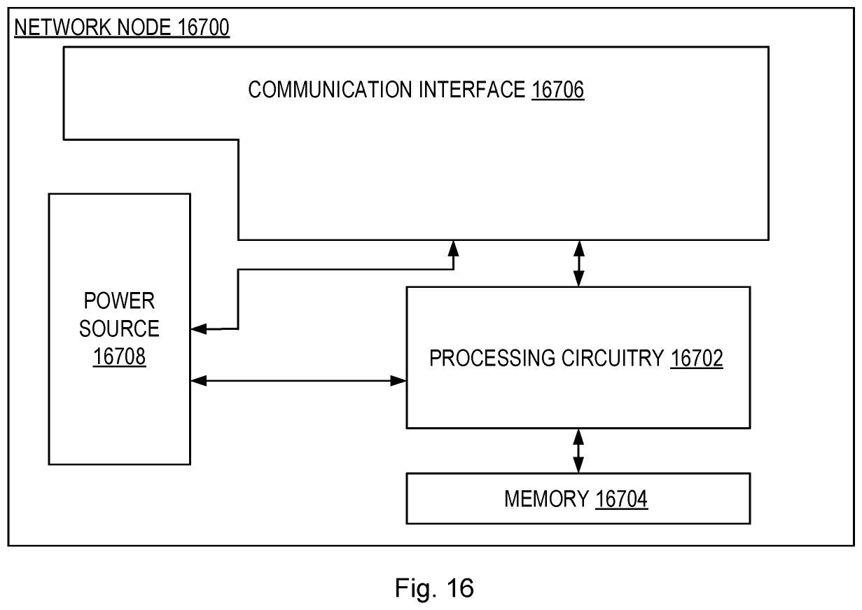

FIG. 16 shows a network node 1600 in accordance with some embodiments. As used herein, network node refers to equipment capable, configured, arranged and/or operable to communicate directly or indirectly with a UE and/or with other network nodes or equipment, in a telecommunication network. The network node 1600 may be operable as a core network node, a core network function or, more generally, a core network entity, such as the core network node 1008 described above with respect to FIG. 10). Examples of network nodes in this context include core network entities such as one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), Policy Control Function (PCF) and/or a User Plane Function (UPF).

The network node 1600 includes processing circuitry 1602, a memory 1604, a communication interface 1606, and a power source 1608, and/or any other component, or any combination thereof. The network node 1600 may be composed of multiple physically separate components, which may each have their own respective components. In certain scenarios in which the network node 1600 comprises multiple separate components, one or more of the separate components may be shared among several network nodes.

The processing circuitry 1602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1600 components, such as the memory 1604, network node 1600 functionality. For example, the processing circuitry 1602 may be configured to cause the network node to perform the methods as described with reference to FIG. 9.

The memory 1604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1602. The memory 1604 may store any suitable instructions, data, or information, including a computer program, software, an application including one or more of logic, rules, code, tables, and/or other instructions capable of being executed by the processing circuitry 1602 and utilized by the network node 1600. The memory 1604 may be used to store any calculations made by the processing circuitry 1602 and/or any data received via the communication interface 1606. In some embodiments, the processing circuitry 1602 and memory 1604 is integrated.

The communication interface 1606 is used in wired or wireless communication of signaling and/or data between a network node, access network, and/or UE.

The power source 1608 provides power to the various components of network node 1600 in a form suitable for the respective components (e.g., at a voltage and current level needed for each respective component). The power source 1608 may further comprise, or be coupled to, power management circuitry to supply the components of the network node 1600 with power for performing the functionality described herein. For example, the network node 1600 may be connectable to an external power source (e.g., the power grid, an electricity outlet) via an input circuitry or interface such as an electrical cable, whereby the external power source supplies power to power circuitry of the power source 1608. As a further example, the power source 1608 may comprise a source of power in the form of a battery or battery pack which is connected to, or integrated in, power circuitry. The battery may provide backup power should the external power source fail.

Embodiments of the network node 1600 may include additional components beyond those shown in FIG. 16 for providing certain aspects of the network node's functionality, including any of the functionality described herein and/or any functionality necessary to support the subject matter described herein. For example, the network node 1600 may include user interface equipment to allow input of information into the network node 1600 and to allow output of information from the network node 1600. This may allow a user to perform diagnostic, maintenance, repair, and other administrative functions for the network node 1600.

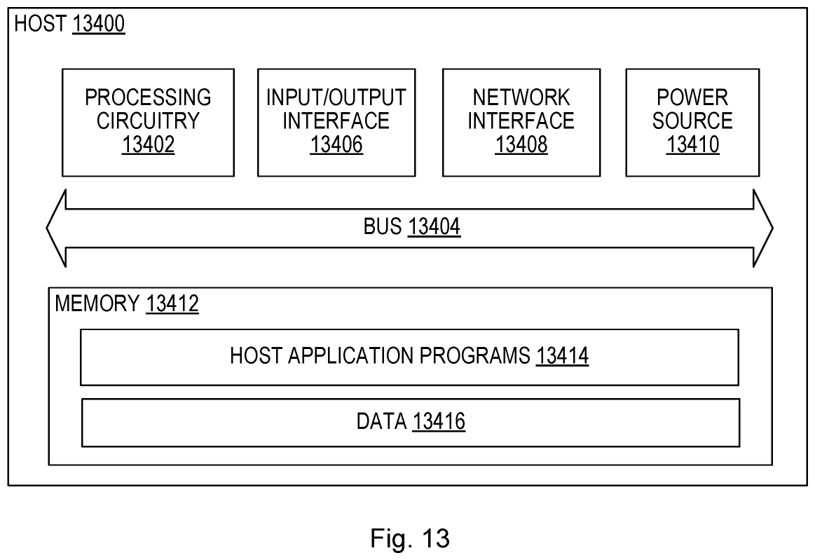

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

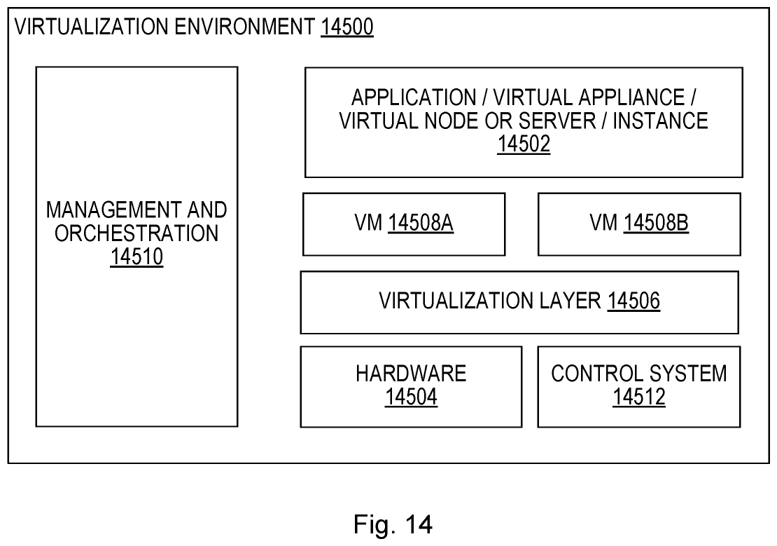

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g. such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

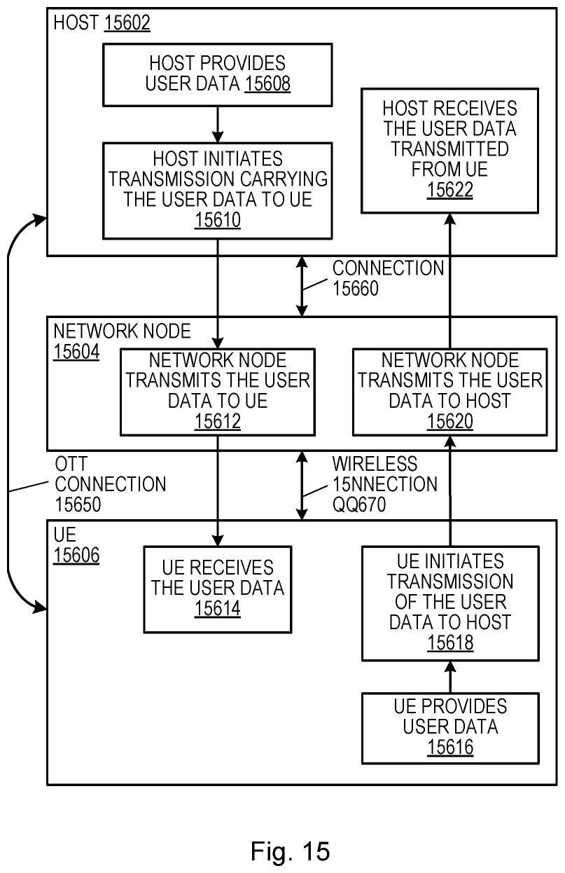

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment. More precisely, the teachings of these embodiments may improve the data rate, latency, power consumption etc., of a UE and/or network node and thereby provide benefits such as reduced user waiting time, relaxed restriction on file size, improved content resolution, better responsiveness, extended battery lifetime etc.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results. The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above, or supplying values of other physical quantities from which software may compute or estimate the monitored quantities. The reconfiguring of the OTT connection 1550 may include message format, retransmission settings, preferred routing etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

For the avoidance of doubt, the following numbered statements set out embodiments of the disclosure:

### Group A Embodiments

1. A method performed by a user equipment, UE, for reporting quality of experience, QoE, information, the method comprising:
   transmitting (706), to a network node of a communications network, a QoE measurement report comprising QoE measurement data associated with an application session between the UE and the communications network; and
   transmitting (708), to the network node, an indication of a connectivity state of the UE with respect to the communications network when the application session was initiated.
2. The method according to embodiment 1, further comprising:
   measuring (704) one or more quality parameters representative of a QoE associated with the application session, wherein the QoE measurement data comprises the one or more quality parameters.
3. The method according to any one of embodiments 1 to 2, wherein the QoE measurement data comprises radio access network, RAN, visible QoE measurement data.
4. The method according to any one of embodiments 1 to 3, wherein the QoE measurement report is a RAN visible QoE measurement report.
5. The method according to any one of embodiments 1 to 4, wherein the indication of the connectivity state of the UE is determined by any one of:
   an application layer of the UE; and
   an access stratum of the UE.
6. The method according to any one of embodiments 1 to 5, wherein responsive to the connectivity state of the UE changing from a first connectivity state to a second connectivity state during the application session, the method further comprises transmitting, to the network node, an indication of one or more of:
   the first connectivity state and the second connectivity state;
   a time period in which the UE was in the first connectivity state before changing to the second connectivity state; and
   a timestamp indicating a time at which the connectivity state of the UE changed.
7 The method according to any one of embodiments 1 to 6, wherein the connectivity state of the UE comprises one or more of:
   a Radio Resource Control, RRC, state;
   a Connection Management, CM, state;
   a 5G Mobility Management, 5GMM, state;
   a Mobility Management, MM, state;
   a Registration Management, RM, state;
   a Registration state;
   an Evolved Packet System, EPS, Connection Management, ECM, state; and
   an EPS Mobility Management, EMM, state.
8. The method according to any one of embodiments 1 to 7, wherein the indication of the connectivity state of the UE is transmitted during the application session.
9. The method according to any one of embodiments 1 to 7, wherein the indication of the connectivity state of the UE is transmitted after the application session has terminated.
10. The method according to any one of embodiments 1 to 9, wherein the indication of the connectivity state of the UE is transmitted in the same transmission as the QoE measurement report.
11. The method according to any one of embodiments 1 to 9, wherein the indication of the connectivity state of the UE is transmitted in a different transmission to the QoE measurement report.
12. The method according to any one of embodiments 1 to 11, wherein the network node is a measurement collection entity, MCE, or a RAN node.
13. The method according to any one of embodiments 1 to 12, further comprising:
   providing user data; and
   forwarding the user data to a host via the transmission to the network node.

### Group B Embodiments

14. A method performed by a radio access network, RAN, node of a communications network for reporting user equipment, UE, quality of experience, QoE, information, the method comprising:
   transmitting (806), to a network node of the communications network, a QoE measurement report comprising QoE measurement data associated with an application session between the UE and the communications network; and
   transmitting (808), to the network node, an indication of a connectivity state of the UE with respect to the communications network when the application session was initiated.
15. The method according to embodiment 14, further comprising:
   receiving (802), from the UE, the QoE measurement report.
16. The method according to any one of embodiments 14 to 15, wherein the QoE measurement data comprises RAN visible QoE measurement data.
17. The method according to any one of embodiments 14 to 16, wherein the QoE measurement report is a RAN visible QoE measurement report.
18. The method according to any one of embodiments 14 to 17, further comprising: determining (804) the indication of the connectivity state of the UE.
19. The method according to embodiment 18, wherein the determination of the indication of the connectivity state of the UE is based on at least one of:
   an indication, received from the UE, that the application session has been initiated by the UE; and
   an indication, received from the UE, that a connection procedure has been initiated by the UE with respect to the communications network.
20. The method according to any one of embodiments 14 to 19, wherein responsive to the connectivity state of the UE changing from a first connectivity state to a second connectivity state during the application session, the method further comprises transmitting, to the network node, an indication of one or more of:
   the first connectivity state and the second connectivity state;
   a time period in which the UE was in the first connectivity state before changing to the second connectivity state; and
   a timestamp indicating a time at which the connectivity state of the UE changed.
21. The method according to any one of embodiments 14 to 20, wherein the connectivity state of the UE comprises one or more of:
   a Radio Resource Control, RRC, state;
   a Connection Management, CM, state;
   a 5G Mobility Management, 5GMM, state;
   a Mobility Management, MM, state;
   a Registration Management, RM, state;
   a Registration state;
   an Evolved Packet System, EPS, Connection Management, ECM, state; and
   an EPS Mobility Management, EMM, state.
22. The method according to any one of embodiments 14 to 21, wherein the indication of the connectivity state of the UE is transmitted during the application session.
23. The method according to any one of embodiments 14 to 21, wherein the indication of the connectivity state of the UE is transmitted after the application session has terminated.
24. The method according to any one of embodiments 14 to 23, wherein the indication of the connectivity state of the UE is transmitted in the same transmission as the QoE measurement report.
25. The method according to any one of embodiments 14 to 23, wherein the indication of the connectivity state of the UE is transmitted in a different transmission to the QoE measurement report.
26. The method according to any one of embodiments 14 to 25, further comprising:
   adapting, based on the QoE measurement report and the indication of the connectivity state of the UE, a configuration parameter relating to a transfer of data between the UE and the communications network.
27. The method according to any one of embodiments 14 to 26, wherein the network node is a measurement collection entity, MCE.
28. The method of any of embodiments 14 to 27, further comprising:
   obtaining user data; and
   forwarding the user data to a host or a user equipment.

### Group C Embodiments

29. A method performed by a network node of a communications network for receiving user equipment, UE, quality of experience, QoE, information, the method comprising:
   receiving a QoE measurement report comprising QoE measurement data associated with an application session between the UE and the communications network; and
   receiving an indication of a connectivity state of the UE with respect to the communications network when the application session was initiated.
30. The method according to embodiment 29, further comprising:
   adapting (906), based on the QoE measurement report and the indication of the connectivity state of the UE, a configuration parameter relating to a transfer of data between the UE and the communications network.
31. The method according to any one of embodiments 29 to 30, wherein the QoE measurement data comprises radio access network, RAN, visible QoE measurement data.
32. The method according to any one of embodiments 29 to 31, wherein the QoE measurement report is a RAN visible QoE measurement report.
33. The method according to any one of embodiments 29 to 32, wherein the QoE measurement report is received from any one of:
   the UE; and
   a RAN node.
34. The method according to any one of embodiments 29 to 33, wherein the indication of the connectivity state of the UE is received from any one of:
   the UE; and
   a RAN node.
35. The method according to any one of embodiments 29 to 34, wherein responsive to the connectivity state of the UE changing from a first connectivity state to a second connectivity state during the application session, the method further comprises receiving an indication of one or more of:
   the first connectivity state and the second connectivity;
   a time period in which the UE was in the first connectivity state before transiting to the second connectivity state;
   a timestamp indicating a time at which the connectivity state of the UE changed.
36. The method according to any one of embodiments 29 to 35, wherein the connectivity state of the UE comprises one or more of:
   a Radio Resource Control, RRC, state;
   a Connection Management, CM, state;
   a 5G Mobility Management, 5GMM, state;
   a Mobility Management, MM, state;
   a Registration Management, RM, state;
   a Registration state;
   an Evolved Packet System, EPS, Connection Management, ECM, state; and
   an EPS Mobility Management, EMM, state.
37. The method according to any one of embodiments 29 to 36, wherein the indication of the connectivity state of the UE is received during the application session.
38. The method according to any one of embodiments 29 to 36, wherein the indication of the connectivity state of the UE is received after the application session has been terminated.
39. The method according to any one of embodiments 29 to 38, wherein the indication of the connectivity state of the UE is received in the same transmission as the QoE measurement report.
40. The method according to any one of embodiments 29 to 38, wherein the indication of the connectivity state of the UE is received in a different transmission to the QoE measurement report.
41. The method according to any one of embodiments 29 to 40, wherein the network node is a measurement collection entity, MCE, or a RAN node.

### Group D Embodiments

42. A user equipment for reporting quality of experience, QoE, information, comprising:
   processing circuitry configured to cause the user equipment to perform any of the steps of any of the Group A embodiments; and
   power supply circuitry configured to supply power to the processing circuitry.
43. A radio access network, RAN, node for reporting user equipment, UE, quality of experience, QoE, information, the RAN node comprising:
   processing circuitry configured to cause the RAN node to perform any of the steps of any of the Group B embodiments;
   power supply circuitry configured to supply power to the processing circuitry.
44. A network node of a communications network for receiving user equipment, UE, quality of experience, QoE, information, the network node comprising:
   processing circuitry configured to cause the network node to perform any of the steps of any of the Group C embodiments;
   power supply circuitry configured to supply power to the processing circuitry.
45. A user equipment (UE) for reporting quality of experience, QoE, information, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE
46. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to receive the user data from the host.
47. The host of the previous embodiment, wherein the cellular network further includes a network node configured to communicate with the UE to transmit the user data to the UE from the host.
48. The host of the previous 2 embodiments, wherein:
   the processing circuitry of the host is configured to execute a host application, thereby providing the user data; and
   the host application is configured to interact with a client application executing on the UE, the client application being associated with the host application.
49. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs any of the operations of any of the Group A embodiments to receive the user data from the host.
50. The method of the previous embodiment, further comprising:
   at the host, executing a host application associated with a client application executing on the UE to receive the user data from the UE.
51. The method of the previous embodiment, further comprising:
   at the host, transmitting input data to the client application executing on the UE, the input data being provided by executing the host application,
   wherein the user data is provided by the client application in response to the input data from the host application.
52. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to transmit the user data to the host.
53. The host of the previous embodiment, wherein the cellular network further includes a network node configured to communicate with the UE to transmit the user data from the UE to the host.
54. The host of the previous 2 embodiments, wherein:
   the processing circuitry of the host is configured to execute a host application, thereby providing the user data; and
   the host application is configured to interact with a client application executing on the UE, the client application being associated with the host application.
55. A method implemented by a host configured to operate in a communication system that further includes a network node and a user equipment (UE), the method comprising:
   at the host, receiving user data transmitted to the host via the network node by the UE, wherein the UE performs any of the steps of any of the Group A embodiments to transmit the user data to the host.
56. The method of the previous embodiment, further comprising:
   at the host, executing a host application associated with a client application executing on the UE to receive the user data from the UE.
57. The method of the previous embodiment, further comprising:
   at the host, transmitting input data to the client application executing on the UE, the input data being provided by executing the host application,
   wherein the user data is provided by the client application in response to the input data from the host application.
58. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
59. The host of the previous embodiment, wherein:
   the processing circuitry of the host is configured to execute a host application that provides the user data; and
   the UE comprises processing circuitry configured to execute a client application associated with the host application to receive the transmission of user data from the host.
60. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of any of the Group B embodiments to transmit the user data from the host to the UE.
61. The method of the previous embodiment, further comprising, at the network node, transmitting the user data provided by the host for the UE.
62. The method of any of the previous 2 embodiments, wherein the user data is provided at the host by executing a host application that interacts with a client application executing on the UE, the client application being associated with the host application.
63. A communication system configured to provide an over-the-top service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
64. The communication system of the previous embodiment, further comprising:
   the network node; and/or
   the user equipment.
65. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
66. The host of the previous embodiment, wherein:
   the processing circuitry of the host is configured to execute a host application, thereby providing the user data; and
   the host application is configured to interact with a client application executing on the UE, the client application being associated with the host application.
67. The host of the any of the previous 2 embodiments, wherein the initiating receipt of the user data comprises requesting the user data.
68. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of the Group B embodiments to receive the user data from the UE for the host.
69. The method of the previous embodiment, further comprising at the network node, transmitting the received user data to the host.

1-38. (canceled)

39. A method performed by a user equipment, UE, for reporting quality of experience (QoE) information, the method comprising:
transmitting, to a network node of a communications network, a QoE measurement report comprising QoE measurement data associated with an application session between the UE and the communications network; and
transmitting, to the network node, an indication of a connectivity state of the UE with respect to the communications network when the application session was initiated.

40. The method according to claim 39, further comprising:
measuring one or more quality parameters representative of a QoE associated with the application session, wherein the QoE measurement data comprises the one or more quality parameters.

41. The method according to claim 39, wherein the QoE measurement data comprises radio access network (RAN) visible QoE measurement data and/or wherein the QoE measurement report is a RAN visible QoE measurement report.

42. The method according to claim 39, wherein responsive to the connectivity state of the UE changing from a first connectivity state to a second connectivity state during the application session, the method further comprises transmitting, to the network node, an indication of one or more of:
the first connectivity state and the second connectivity state;
a time period in which the UE was in the first connectivity state before changing to the second connectivity state; and
a timestamp indicating a time at which the connectivity state of the UE changed.

43. The method according to claim 39, wherein the connectivity state of the UE comprises one or more of:
a Radio Resource Control (RRC) state;
a Connection Management (CM) state;
a 5G Mobility Management (5GMM) state;
a Mobility Management (MM) state;
a Registration Management (RM) state;
a Registration state;
an Evolved Packet System (EPS) Connection Management (ECM) state; and
an EPS Mobility Management (EMM) state.

44. The method according to claim 39, wherein the network node is a measurement collection entity (MCE) or a RAN node.

45. The method according to claim 39, wherein the connectivity state is an inactive state or an idle state.

46. A method performed by a radio access network (RAN) node of a communications network for reporting user equipment (UE) quality of experience (QoE) information, the method comprising:
transmitting, to a network node of the communications network, a QoE measurement report comprising QoE measurement data associated with an application session between the UE and the communications network; and
transmitting, to the network node, an indication of a connectivity state of the UE with respect to the communications network when the application session was initiated.

47. The method according to claim 46, further comprising receiving the QoE measurement report from the UE.

48. The method according to claim 46, further comprising determining the indication of the connectivity state of the UE.

49. The method according to claim 46, wherein the determination of the indication of the connectivity state of the UE is based on at least one of:
an indication, received from the UE, that the application session has been initiated by the UE; and
an indication, received from the UE, that a connection procedure has been initiated by the UE with respect to the communications network.

50. The method according to claim 46, wherein responsive to the connectivity state of the UE changing from a first connectivity state to a second connectivity state during the application session, the method further comprises transmitting, to the network node, an indication of one or more of:
the first connectivity state and the second connectivity state;
a time period in which the UE was in the first connectivity state before changing to the second connectivity state; and
a timestamp indicating a time at which the connectivity state of the UE changed.

51. The method according to claim 46, further comprising adapting, based on the QoE measurement report and the indication of the connectivity state of the UE, a configuration parameter relating to a transfer of data between the UE and the communications network.

52. The method according to claim 46, wherein the network node is a measurement collection entity (MCE).

53. A user equipment (UE) for reporting quality of experience (QoE) information, the UE comprising:
processing circuitry configured to cause the UE to:
transmit, to a network node of a communications network, a QoE measurement report comprising QoE measurement data associated with an application session between the UE and the communications network; and
transmit, to the network node, an indication of a connectivity state of the UE with respect to the communications network when the application session was initiated; and
power supply circuitry configured to supply power to the processing circuitry.

54. A radio access network (RAN) node for reporting user equipment (UE) quality of experience (QoE) information, the RAN node comprising:
processing circuitry configured to cause the RAN node to:
transmit, to a network node of the communications network, a QoE measurement report comprising QoE measurement data associated with an application session between the UE and the communications network; and
transmit, to the network node, an indication of a connectivity state of the UE with respect to the communications network when the application session was initiated; and
power supply circuitry configured to supply power to the processing circuitry.
